(19) United States
(12) Patent Application Publication
(10) Pub. No.: US 2006/0277231 A1
(43) Pub. Date: Dec. 7, 2006

(54) Integrated software development and porting system for wireless devices

(75) Inventors: Alexandre R. Kral, Laguna Niguel, CA (US); Xavier F. Kral, Brussels (BE)

Correspondence Address: MCDERMOTT WILL & EMERY LLP, 18191 VON KARMAN AVE., SUITE 500, IRVINE, CA, 92612-7108, US

(73) Assignee: Javaground USA, Inc., Laguna Niguel, CA (US)

(21) Appl. No.: 11/191,957

(22) Filed: Jul. 29, 2005

Related U.S. Application Data
(60) Provisional application No. 60/688,243, filed on Jun. 6, 2005.

(51) Int. Cl. G06J 1/02

(52) U.S. Cl. 708/102

(57) ABSTRACT

An integrated computer system and a method for developing a source code and for generating executable computer programs to be run on multiple wireless devices are provided. A computer system includes a wireless device selector, a universal and concurrent emulator, a build and porting engine, a resource manager, and a provisioning server. The computer system utilizes a source code, a database including attributes of wireless devices, one or more libraries containing generic libraries and specific libraries relating to the wireless devices, and resources for the wireless devices. After certain wireless devices are selected, the universal and concurrent emulator can automatically emulate the selected devices and automatically and concurrently test the source code on the emulated devices. The build and porting engine can automatically generate executable computer programs for at least some or all of the selected wireless devices. The build and porting engine can also provide the executable computer programs to the provisioning server, which can provide the executable computer programs to their respective wireless devices. After the executable computer programs are tested on the actual wireless devices, the test results and comments can be fed back to the provisioning server. The system uses a single source code, and the source code can be modified based on emulation test results and actual test results. The resource manager can manipulate and optimize the resources. The emulator, build and porting engine, resource manager, and provisioning server can share the same source code, database, libraries, and resources.

### CROSS-REFERENCES TO RELATED APPLICATIONS

This present application claims the benefit of priority under 35 U.S.C. §1119 from U.S. Provisional Patent Application No. 60/688,243, filed Jun. 6, 2005, titled “An Integrated Software Development and Porting System for Wireless Devices,” which is hereby incorporated by reference in its entirety for all purposes. The present application is related to U.S. Non-Provisional patent application Ser. No. 11/191,975, filed Jul. 29, 2005, entitled “Efficient and Automatic Software Application Development System for Wireless Devices,” and also assigned to the Assignee of the present invention. The related application is hereby incorporated by reference.

### FIELD OF THE INVENTION

The present invention relates to software development and porting, and, more particularly, relates to J2ME application development and porting for wireless devices.

### BACKGROUND OF THE INVENTION

Over the past few years, wireless devices have become ubiquitous. The computing power of these wireless devices has also been increasing at a rapid pace, enabling a variety of applications to be utilized on wireless devices. Among those, the most demanding are video games.

The most common platforms used to run applications on wireless devices include, for example, Java 2 Micro Edition (J2ME), BREW, PalmOS, and Windows Mobile. Even though an application written for J2ME should run on all devices supporting that platform, reality has shown this is not the case. The main reasons are that the wireless devices have different features (for example, size of the screen, processor speed, memory, and keyboards) and that their J2ME implementation has been programmed by different manufacturers, leading to slightly different implementation that is not fully compatible. Because the wireless devices are different in their hardware and software implementations, an application created for device A will most likely not run on device B. Developers are thus forced to customize their applications for the different devices. This is called porting and it is currently one of the main costly components in creating applications for wireless devices today.

The process of developing applications for wireless devices like cellular phones is fairly inefficient for most developers. For instance, after the game concept has been established, the art and the source code are created. The source code is then compiled (into ajar file in the case of J2ME) and tested either on an actual device (e.g., a cellular phone) or on a particular emulator designed by the manufacturer. Testing the code on an actual device or on an emulator is quite cumbersome, and in most cases, the use of a debugger is not allowed. Also, the loading of the compiled application on the actual device or in the emulator may be fairly time consuming.

After the code has been debugged on one device, it now needs to be tested and debugged on all the other devices, which is a repetitive and slow process. Moreover, the building of all these executable files is usually done in a serial fashion and tends to be time consuming as well.

Overall, the porting process is tedious and time consuming because every new version of the application is created separately (by different people or in a sequential manner). The porting process relies mostly on manual porting of the application source code to target the other wireless devices. This can take many different forms from having different modules of source code being used by the different implementations or by having separate source codes or even by modifying the original executable binary code to adapt it to the new device. This is inefficient because it requires maintaining different source codes and/or different executable files for each version of the application. In addition, future applications will have to undergo the same inefficient treatment of adding new source modules or modifying their executable results to port these applications to the desired wireless devices.

The process is also manually intensive since all the processes pertaining to modifying the source code are handled by people and are thus error prone. Altogether this adds complexity and inefficiency which translates into longer and more expensive development and porting cycles.

Accordingly, it would be desirable to be able to create all or multiple versions of an application all at once from a single source code and also be able to emulate all these versions or multiple versions at once in an integrated environment where a debugger is readily available. It would also be desirable to be able to target some specific devices from a database for a particular distribution. In addition, the management of resource files could be greatly simplified and their quality improved by the use of a dedicated resource manager software.

### SUMMARY OF THE INVENTION

The present invention provides methods and apparatus for efficient and automatic development and porting of computer programs for wireless devices (e.g., computer games for cellular phones). According to one aspect of the present invention, a computer system includes a wireless device selector, a universal and concurrent emulator, a build and porting engine, a resource manager, and a provisioning server. The computer system utilizes a source code, one or more databases including attributes of wireless devices, one or more libraries containing generic libraries and specific libraries relating to the wireless devices, and one or more repositories containing resources for the wireless devices.

According to one aspect of the present invention, after certain wireless devices are selected (e.g., select 200 wireless devices from a database of 1,000 wireless devices), the universal and concurrent emulator can automatically emulate the selected devices and automatically and concurrently test the source code on the emulated devices. The build and porting engine can automatically generate executable computer programs for at least some or all of the selected wireless devices. The build and porting engine can also provide the executable computer programs to the provisioning server, which can provide the executable computer programs to their respective wireless devices. After the executable computer programs are tested on the actual wireless devices, the test results and comments can be fed back to the provisioning server.

According to another aspect of the present invention, the system uses a single source code, and the source code can be modified based on emulation test results and actual test results. The resource manager can manipulate and optimize the resources. The emulator, build and porting engine, resource manager, and provisioning server can share the same source code, database, libraries, and resources.

According to yet another aspect of the present invention, executables for wireless devices can be automatically generated based on the selection of the wireless devices, attributes of the wireless devices, information from libraries, resources, and a version of the source code. An executable may be used by one or more wireless devices. The number of executables can be minimized by grouping or sorting automatically the selected wireless devices into categories (or bins) based on their characteristics, where the number of categories (or bins) is less than the number of the selected wireless devices. An executable is generated for each category rather than each wireless device, and thus the number of executables is reduced.

According to another aspect of the present invention, if a selected device fails to meet a grouping test criterion, then the device can be either excluded from being grouped into a category or grouped into a category that closely matches the attributes of the failed device.

According to another aspect of the present invention, executables for wireless devices can also be automatically generated based on the selection of the wireless devices, attributes of the wireless devices, translation information from specific libraries, resources, and a version of source code. The translation information can include wrapper routines and specific routines. When a wrapper routine is called or utilized, the corresponding specific routines are implemented in the final executables.

According to another aspect of the present invention, a resource manager can generate resources by generating a plurality of series and a plurality of contexts, where one series can generate another one or more series automatically and simultaneously. A resource manager can also manipulate resources by sorting automatically resources by size, rearranging automatically the resources, reducing automatically the number of colors, and applying a filter on the resources based on a threshold.

According to another aspect of the present invention, after certain wireless devices are selected, executables for the selected devices are generated based on attributes of the selected wireless devices, resources appropriate for the selected wireless devices, a version of source code, and one or more specific libraries. A specific library includes one or more wrapper routines that can wrap certain differences of at least some of the selected wireless devices under “universal” routine names. During the process of generating the executables, the specific library translates the one or more wrapper routines into one or more specific routines for each of the at least some of the selected wireless devices so that the one or more wrapper routines are implemented differently in the executables for the at least some of the wireless devices using the one or more specific routines.

According to another aspect of the present invention, one or more emulated devices can be generated based on attributes of selected wireless devices, library information, and resources appropriate for the selected wireless devices. An emulated device (or a virtual model) can represent one or more wireless devices. A universal emulator can generate one or more universal emulated devices, wherein each universal emulated device represents at least two or more wireless devices.

According to another aspect of the present invention, a concurrence emulator can generate at least two or more emulated devices, wherein each can represent one or more wireless devices. The concurrent emulator can generate emulated devices simultaneously. The concurrent emulator also allows the emulated devices to receive one or more inputs (e.g., button presses, network data, phone events, http requests) simultaneously for testing. Different versions of source code can be provided to and tested on the emulated devices simultaneously in that, for example, one version of the source code can be tested on one emulated device, while another version of the source code is tested on another emulated device simultaneously. A code-formatter can create these different versions of source code. According to another aspect of the present invention, a same version(s) of source code can be provided to and tested on emulated devices simultaneously

According to another aspect of the present invention, there is provided an integrated apparatus or an integrated computer system for developing a source computer program and for generating a plurality of executable computer programs to be run on a plurality of wireless devices, the integrated system comprising: a database including attributes of at least the plurality of wireless devices; one or more libraries; resources; an emulator for receiving one or more versions of the source computer program, for receiving information from the database, the one or more libraries, and the resources, for generating a first emulated device and a second emulated device based on the information, the first and second emulated devices for receiving at least one or more inputs substantially simultaneously; a porting engine for receiving a version of the source computer program, for receiving information from the database, the one or more libraries, and the resources, and for generating a plurality of executable computer programs to be run on the plurality of wireless devices, wherein the first emulated device represents at least a first one of the plurality of wireless devices, wherein the second emulated device represents at least a second one of the plurality of wireless devices, wherein the version of the source computer program is either the same as or different from the one or more versions of the source computer program.

According to another aspect of the present invention, there is provided an integrated apparatus or an integrated computer system further comprising: a resource manager for manipulating and optimizing the resources; a code-formatter for activating or deactivating a portion of a version of the source computer program based on a preprocessor command; a provisioning server for receiving the plurality of executable computer programs and for transmitting the plurality of executable computer programs to the plurality of wireless devices, wherein the first emulated device represents at least the first one and a third one of the plurality of wireless devices; wherein when a first version of the one or more versions of the source computer program is tested on the first emulated device, a second version of the one or more versions of the source computer program is tested on the second emulated device substantially simultaneously, wherein the one or more libraries include a common routine associated with at least a first specific routine and a second specific routine, wherein the first specific routine is for the first one of the plurality of wireless devices, wherein the second specific routine is for the third one of the plurality of wireless devices, wherein the common routine is for both the first one and the third one of the plurality of wireless devices, wherein to generate the plurality of executable computer programs to be run on the plurality of wireless devices, the porting engine is capable of grouping automatically representations of the plurality of wireless devices into a plurality of device categories and generating automatically the plurality of executable computer programs for the plurality of device categories.

According to another aspect of the present invention, there is provided an integrated apparatus or an integrated computer system wherein each of the following is for being updated by retrieving an update from a repository or a server: the database, the one or more libraries, the emulator, the porting engine, and the resource manager, wherein if the plurality of executable computer programs is to be modified, the porting engine is capable of generating automatically a modified plurality of executable computer programs without manually or sequentially modifying the plurality of executable computer programs by having one or more of the following modified: one version of the source computer program, information in the database, information in the one or more libraries, and the resources, wherein the number of the plurality of device categories is less than the number of the plurality of wireless devices, wherein the number of the plurality of executable computer programs is less than the number of the plurality of wireless devices.

According to another aspect of the present invention, there is provided a method or a method for operating a computer system comprising: retrieving attributes of a first plurality of wireless devices, each of the first plurality of wireless devices for running an application and having a screen; receiving translation information including one or more common routines available for the first plurality of wireless devices; receiving resources appropriate for the first plurality of wireless devices; receiving a first version of a source computer program; generating a first emulated device representing the first plurality of wireless devices based on at least the attributes; testing the first version of the source computer program on the first emulated device representing the first plurality of wireless devices, wherein a first one of the first plurality of wireless devices is of a different type than a second one of the first plurality of wireless devices.

According to another aspect of the present invention, there is provided a method or a method for operating a computer system further comprising: generating a second emulated device representing one or more wireless devices; testing a second version of the source computer program on the second emulated device, the first and second emulated devices receiving at least one or more inputs substantially simultaneously, wherein the steps of testing the first version of the source computer program on the first emulated device and testing a second version of the source computer program on the second emulated device occur substantially simultaneously.

According to another aspect of the present invention, there is provided a method or a method for operating a computer system further comprising: selecting a plurality of wireless devices, wherein the plurality of wireless devices include the first plurality of wireless devices and the one or more wireless devices, wherein the step of generating a second emulated device is based on attributes of the one or more wireless devices, wherein the steps of generating a first emulated device representing the first plurality of wireless devices and generating a second emulated device representing one or more wireless devices occur substantially simultaneously.

According to another aspect of the present invention, there is provided a method or a method for operating a computer system wherein at least one of the one or more common routines is for the first emulated device representing the first plurality of wireless devices, wherein a first specific routine for the first one of the first plurality of wireless devices and a second specific routine for the second one of the first plurality of wireless devices are associated with the at least one of the one or more common routines for the first emulated device, wherein the first specific routine and the second specific routine are different in that the first specific routine is not capable of being used for the second one of the first plurality of wireless devices, wherein the step of testing the first version of the source computer program on the first emulated device uses the at least one of the one or more common routines, wherein the at least one of the one or more common routines allows a single version of the source computer program to be used with the first emulated device representing the first plurality of wireless devices.

According to another aspect of the present invention, there is provided a method or a method for operating a computer system wherein the one or more common routines include at least one of: a routine to manage or play audio, a routine to manage or use a communication network, and a routine to manage full screen.

According to another aspect of the present invention, there is provided a method or a method for operating a computer system wherein the source computer program is in one of: Java or Java 2 Micro Edition, wherein the attributes include screen resolutions of the first plurality of wireless devices.

According to another aspect of the present invention, there is provided a method or a method for operating a computer system further comprising: activating or deactivating a portion of a version of the source computer program based on a preprocessor command.

According to another aspect of the present invention, there is provided a method or a method for operating a computer system wherein the step of activating or deactivating is further based on a logic test, wherein the step of activating or deactivating is performed in a single action.

According to another aspect of the present invention, there is provided a method or a method for operating a computer system wherein the step of activating or deactivating allows testing of different behaviors on the first emulated device using the single source computer program, wherein the preprocessor command is compatible with a Java code compiler or a Java integrated development environment.

According to another aspect of the present invention, there is provided a method or a method for operating a computer system further comprising: generating automatically a plurality of executable computer programs for a plurality of wireless devices based on attributes of the plurality of wireless devices, elements of one or more libraries, resources appropriate for the plurality of wireless devices, and a version of the source computer program.

According to another aspect of the present invention, there is provided a method or a method for operating a computer system further comprising: creating a plurality of series, each series including a set of resources; creating a plurality of contexts, each context including a plurality of series; minimizing an amount of space occupied by a set of resources.

According to another aspect of the present invention, there is provided a method or a method for operating a computer system wherein the step of receiving resources appropriate for the first plurality of wireless devices comprises: selecting a set of resources that closely matches the attributes of the first plurality of wireless devices.

According to another aspect of the present invention, there is provided a method or a method for operating a computer system further comprising: providing the plurality of executable computer programs for the plurality of wireless devices to a server; providing the plurality of executable computer programs from the server to corresponding ones of the plurality of wireless devices, wherein the step of retrieving attributes retrieves the attributes from a database, wherein the step of receiving translation information receives the translation information from the one or more libraries, wherein the step of receiving resources receives the resources from a repository of all resources, the repository including contexts, wherein the step of generating a first emulated device representing the first plurality of wireless devices uses information from the same database, wherein the step of testing the first version of the source computer program on the first emulated device uses information from the same one or more libraries and the same repository, wherein the step of generating a second emulated device representing one or more wireless devices uses information from the same database, wherein the steps of testing the first version of the source computer program on the first emulated device and testing a second version of the source computer program on the second emulated device use information from the same one or more libraries and the same repository, wherein the step of generating automatically a plurality of executable computer programs for a plurality of wireless devices uses information from the same database, the same one or more libraries, and the same repository, wherein attributes associated with any of the plurality of wireless devices are current.

According to another aspect of the present invention, there is provided a method or a method for operating a computer system wherein the step of generating a first emulated device representing the first plurality of wireless devices utilizes at least one of the plurality of series and one of the plurality of contexts; wherein the step of generating a second emulated device representing one or more wireless devices utilizes at least one of the plurality of series and one of the plurality of contexts, wherein the step of generating automatically a plurality of executable computer programs for a plurality of wireless devices utilizes at least one of the plurality of series and one of the plurality of contexts.

According to another aspect of the present invention, there is provided a method or a method for operating a computer system wherein each of the steps of testing the first version of the source computer program on the first emulated device, testing a second version of the source computer program on the second emulated device, and generating automatically a plurality of executable computer programs for a plurality of wireless devices utilizes a graphical user interface.

According to another aspect of the present invention, there is provided a method or a method for operating a computer system wherein the step of testing the first version of the source computer program uses at least the translation information and the resources, wherein manufacturers of the first one of the first plurality of wireless devices and the second one of the first plurality of wireless devices are different.

According to another aspect of the present invention, there is provided a method or a method for operating a computer system comprising: retrieving attributes of a plurality of wireless devices; receiving resources appropriate for the plurality of wireless devices; generating a plurality of emulated devices representing the plurality of wireless devices based on at least the attributes; testing a version of the source computer program on a first one of the plurality of emulated devices; testing a version of the source computer program on a second one of the plurality of emulated devices substantially simultaneously with the step of testing a version of the source computer program on a first one of the plurality of emulated devices, wherein the first one and the second one of the plurality of emulated devices receive substantially simultaneously a first input for testing, wherein the first one and the second one of the plurality of emulated devices receive substantially simultaneously a second input for testing.

According to another aspect of the present invention, there is provided a method or a method for operating a computer system further comprising: displaying the first one and second one of the plurality of emulated devices on a screen substantially simultaneously.

According to another aspect of the present invention, there is provided a method or a method for operating a computer system comprising: selecting a plurality of wireless devices by selecting device representations, each of the device representations representing a corresponding one of the plurality of wireless devices; receiving attributes of the plurality of wireless devices; receiving information from one or more libraries; receiving resources appropriate for the plurality of wireless devices; receiving a version of a source computer program; generating a plurality of executable computer programs for at least some or all of the plurality of wireless devices based on the selection of the plurality of wireless devices, the attributes of the plurality of wireless devices, the information from the one or more libraries, the resources, and the version of the source computer program, wherein the step of generating a plurality of executable computer programs comprises: grouping automatically the device representations into a plurality of device categories; generating automatically the plurality of executable computer programs for the plurality of device categories, wherein the number of the plurality of device categories is less than the number of the plurality of wireless devices, wherein the number of the plurality of executable computer programs is less than the number of the plurality of wireless devices, wherein the plurality of executable computer programs are for being run on the at least some or all of the plurality of wireless devices, wherein at least one of the plurality of executable computer programs is for being run on at least two of the plurality of wireless devices.

According to another aspect of the present invention, there is provided a method or a method for operating a computer system wherein the step of generating a plurality of executable computer programs further comprises: preprocessing automatically a version of the source computer program to generate substantially simultaneously a plurality of versions of the source computer program; assembling automatically the plurality of versions of the source computer program, the information from the one or more libraries, and the resources; matching automatically and closely the plurality of versions of the source computer program, the information from the one or more libraries, and the resources; compiling automatically the plurality of versions of the source computer program and the information from the one or more libraries that are matched to generate a first output; post-processing the first output to generate the plurality of executable computer programs.

According to another aspect of the present invention, there is provided a method or a method for operating a computer system further comprising: providing the plurality of executable computer programs to a server; providing the plurality of executable computer programs from the server to corresponding ones of the plurality of wireless devices.

According to another aspect of the present invention, there is provided a method or a method for operating a computer system wherein if an additional wireless device is selected, then an executable computer program for the additional wireless device is generated automatically without updating a script file or manually modifying a file, except that a file or files, in which the additional wireless device selection is made, are modified if such a file or files exist.

According to another aspect of the present invention, there is provided a method or a method for operating a computer system wherein if one of the resources is removed or an additional resource is added, then the plurality of executable computer programs is generated automatically using appropriate resources available without updating a script file or manually modifying a file, except that a file or files, in which the one of the resources is removed or the additional resource is added, are modified wherein if a resource appropriate for one of the plurality of wireless device is not available, then a resource that closely matches the appropriate resource is used; wherein if some of the information in the one or more libraries is removed or additional information is added to the one or more libraries, then the plurality of executable computer programs is generated automatically without updating a script file or manually modifying a file, except for modifying the one or more libraries in which the some of the information is removed or where the additional information is added.

According to another aspect of the present invention, there is provided a method or a method for operating a computer system wherein the plurality of device categories is not generated prior to the step of grouping, wherein if an attribute of one of the plurality of wireless devices does not meet a grouping test criterion, then one of the device representations corresponding to the one of the plurality of wireless devices is excluded from the step of grouping or is grouped into a device category that closely matches the attribute of the one of the plurality of wireless devices.

According to another aspect of the present invention, there is provided a method or a method for operating a computer system wherein the step of grouping automatically the device representations into a plurality of device categories is performed based on the selection of the plurality of wireless devices and at least one or more test criteria based on one or more of: attributes of the plurality of wireless devices, wireless device implementations, resources, libraries, the source computer program, preprocessor commands, one or more demultiplexers based on selected properties of wireless devices, and application programming interfaces.

According to another aspect of the present invention, there is provided a method or a method for operating a computer system wherein the step of generating a plurality of executable computer programs creates a minimum number of executable computer programs for the plurality of wireless devices.

According to another aspect of the present invention, there is provided a method or a method for operating a computer system wherein the plurality of executable computer programs is generated all at once in a batch process.

According to another aspect of the present invention, there is provided a method or a method for operating a computer system further comprising: generating a matching file for the plurality of executable computer programs, wherein the matching file includes information to designate which executable computer program is to be used with which wireless device.

According to another aspect of the present invention, there is provided a method or a method for operating a computer system further comprising: testing one of the plurality of executable computer programs on one of the plurality of wireless devices, wherein if the one of the plurality of wireless devices fails a test, then an executable computer program associated with the failed wireless device is automatically excluded from the plurality of executable computer programs.

According to another aspect of the present invention, there is provided a method or a method for operating a computer system further comprising: providing a matching file; testing one of the plurality of executable computer programs on one of the plurality of wireless devices; providing a test result to the server; receiving the test result from the server, wherein the step of providing the plurality of executable computer programs to a server is performed automatically, wherein comments included in the test result are capable of being displayed.

According to another aspect of the present invention, there is provided a method or a method for operating a computer system further comprising: generating a list of the plurality of executable computer programs created; generating a list of wireless devices for which the plurality of executable computer programs are created; identifying a wireless device for which no executable computer program is created because one or more attributes of the wireless device fail to meet the at least one or more test criteria; identifying a wireless device whose executable computer program size is larger than a maximum executable computer program size allowed.

According to another aspect of the present invention, there is provided a method or a method for operating a computer system wherein a configuration file defines directories to allow additional resources to be used for at least one of the plurality of executable computer programs.

According to another aspect of the present invention, there is provided a method or a method for operating a computer system further comprising: generating a plurality of series, each series including a set of resources; generating a plurality of contexts, each context including a plurality of series, wherein a first context of the plurality of contexts is a parent context, and a second context of the plurality of contexts is a child context, wherein the child context inherits resources from the parent context except for resources that are defined within the child context, wherein a context or a series is capable of including additional one or more directories to allow additional resources to be associated with an executable computer program for a wireless device, wherein an amount of space occupied by resources is minimized by the usage of the parent and child contexts.

According to another aspect of the present invention, there is provided a method or a method for operating a computer system wherein the source computer program is for an application for a video game, wherein the plurality of wireless device includes cellular phones.

According to another aspect of the present invention, there is provided a method or a method for operating a computer system wherein the attributes include one or more of the following information of the plurality of wireless devices: screen resolution, keyboard mapping, supported application programming interfaces, connectivity, image formats, audio formats, cameras, interface connections, and carriers.

According to another aspect of the present invention, there is provided a method, or a method for operating a computer system, for generating or manipulating resources for an application for wireless devices, comprising: generating a plurality of series, each series including a set of resources, wherein resources are for an application for wireless devices; generating a plurality of contexts, each context including a plurality of series, wherein the step of generating a plurality of series comprises: generating a first series of the plurality of series, the first series including a first set of resources; wherein the step of generating a plurality of series further comprises at least one of: generating a second series of the plurality of series based on the first series of the plurality of series by automatically manipulating the first set of resources to generate a second set of resources, wherein the second series of the plurality of series includes the second set of resources, or generating a second series of the plurality of series and a third series of the plurality of series based on the first series of the plurality of series by automatically manipulating the first set of resources to generate a second set of resources and a third set of resources substantially simultaneously, wherein the second series of the plurality of series includes the second set of resources, and wherein the third series of the plurality of series includes the third set of resources, wherein the resources are to be used to generate executable computer programs for the wireless devices.

According to another aspect of the present invention, there is provided a method or a method for operating a computer system wherein the first set of resources is for a first screen resolution or a first range of screen resolutions, wherein the second set of resources is for a second screen resolution or a second range of screen resolutions, wherein the third set of resources is for a third screen resolution or a third range of screen resolutions, wherein the resources are images, wherein the step of generating a second series of the plurality of series requires resizing the first set of resources, wherein the step of generating a second series of the plurality of series and a third series of the plurality of series requires resizing the first set of resources.

According to another aspect of the present invention, there is provided a method or a method for operating a computer system further comprising: assigning names to resources; utilizing the names in a source computer program for the application for the wireless devices.

According to another aspect of the present invention, there is provided a method or a method for operating a computer system further comprising one or more of: manipulating some or all of resources in a series substantially simultaneously in parallel; manipulating some or all of resources in different series substantially simultaneously in parallel; and manipulating some or all of resources in different contexts substantially simultaneously in parallel.

According to another aspect of the present invention, there is provided a computer program method, or a method for operating a computer system, for manipulating resource images for an application for one or more wireless devices, comprising: sorting automatically resource images by size, the resource images to be used to generate one or more executable computer programs for one or more wireless devices, rearranging automatically the resource images to minimize an amount of space occupied by the resource images; reducing automatically the number of colors associated with the resource images based on an input; applying a filter on the resource images based on a threshold.

According to another aspect of the present invention, there is provided a computer program method or a method for operating a computer system further comprising: displaying on a screen a result of the step of reducing automatically the number of colors associated with the resource images based on an input; displaying on a screen a result of the step of applying a filter on the resource images based on a threshold.

According to another aspect of the present invention, there is provided a method, or a method for operating a computer system, for generating executable computer programs for wireless devices comprising: selecting a plurality of wireless devices; receiving attributes of the plurality of wireless devices; receiving translation information from one or more libraries, the translation information including at least a common routine for at least two of the plurality of wireless devices and specific routines, each specific routine for a corresponding one of the at least two of the plurality of wireless devices, the common routine for wrapping at least a difference of the at least two of the plurality of wireless devices; receiving resources appropriate for the plurality of wireless devices; generating automatically a plurality of executable computer programs for at least some or all of the plurality of wireless devices based on the selection of the plurality of wireless devices, the attributes of the plurality of wireless devices, the translation information, the resources, and a source computer program, wherein when the common routine is called or utilized, a first one of the plurality of executable computer programs for a first one of the at least two of the plurality of wireless devices implements a first one of the specific routines, and a second one of the plurality of executable computer programs for a second one of the at least two of the plurality of wireless devices implements a second one of the specific routines.

According to another aspect of the present invention, there is provided a method or a method for operating a computer system wherein the translation information further includes correlation information between the common routine and the specific routines, wherein when the common routine is called or utilized, the common routine is called by the source computer program, and the translation information provides the specific routines for the at least two of the plurality of wireless devices based on the common routine and the correlation information.

According to another aspect of the present invention, there is provided an integrated apparatus or an integrated computer system for developing a source computer program and for generating a plurality of executable computer programs to be run on a plurality of wireless devices, the integrated apparatus or the integrated computer system comprising: a database for storing attributes of at least the plurality of wireless devices; one or more libraries having generic data which is available for the plurality of wireless devices and specific data which is available for at least some of the plurality of wireless devices; a resource repository for storing a plurality of resources appropriate for the plurality of wireless devices; an emulator for emulating at least two or more of the plurality of wireless devices by generating a virtual model for each of the at least two or more of the plurality of wireless devices to be emulated, wherein each virtual model is generated based on inputs received from the database, the one or more libraries and the resource repository; and a porting engine for receiving a version of the source computer program and for generating the plurality of executable computer programs based on the version, wherein the plurality of executable computer programs is generated based on inputs received from the database, the one or more libraries and the resource repository.

According to another aspect of the present invention, there is provided an integrated apparatus or an integrated computer system further comprising a resource manager for controlling the plurality of resources, wherein the emulator is arranged to generate a plurality of the virtual models simultaneously.

According to another aspect of the present invention, there is provided an integrated apparatus or an integrated computer system, wherein the specific data in the one or more libraries is arranged to account for differences in at least some of the plurality of wireless devices in that the specific data comprises: specific routines, each of which is a computer routine specific to corresponding one or more of the at least some of the plurality of wireless devices; and at least a wrap routine arranged to wrap the differences of the specific routines into a universal routine which is a computer routine available for the at least some of the plurality of wireless devices.

According to another aspect of the present invention, there is provided an integrated apparatus or an integrated computer system, wherein the porting engine is able to generate the plurality of executable computer programs from the version of the source computer program by taking into account differences of the at least some of the plurality of wireless devices using the specific data in the one or more libraries wherein wrap routines are translated by the specific data in the one or more libraries into specific routines for specific wireless devices when generating the plurality of executable computer programs.

According to another aspect of the present invention, there is provided an integrated apparatus or an integrated computer system, wherein the emulator uses the specific data in the one or more libraries to account for the differences in the at least some of the plurality of wireless devices in providing a universal emulated device, which is a virtual model for at least two or more of the plurality of wireless devices.

According to another aspect of the present invention, there is provided an integrated apparatus or an integrated computer system, wherein the emulator, the porting engine, the resource repository, and the one or more libraries are all connected to the same database to allow attributes associated with any of the plurality of wireless devices to be current.

According to another aspect of the present invention, there is provided an integrated apparatus or an integrated computer system further comprising a coder-formatter which is arranged to operate on a set of preprocessor commands introduced in the source computer program for identifying separate portions of the source computer program.

According to another aspect of the present invention, there is provided an integrated apparatus or an integrated computer system, wherein the emulator is capable of testing the identified separate portions of the source computer program using the set of preprocessor commands and wherein the porting engine is capable of modifying the source computer program from which the plurality of executable computer programs are generated using the preprocessor commands.

According to another aspect of the present invention, there is provided an integrated apparatus or an integrated computer system further comprising: a first user-interface enabling wireless devices to be selected from a list whereafter the executable computer programs associated with at least some of the selected wireless devices are automatically generated in parallel without human intervention; and a second user-interface enabling wireless devices to be selected from a list whereafter virtual models associated with at least some of the selected wireless devices are automatically generated in parallel without human intervention, wherein the first and second user-interfaces are either the same or different.

According to another aspect of the present invention, there is provided an integrated apparatus or an integrated computer system, wherein the plurality of resources is arranged into a set of series each comprising one or more of the resources and as a set of contexts each comprising one or more of the series, wherein sets of series and contexts define selections of user-interface themes for the plurality of wireless devices.

According to another aspect of the present invention, there is provided an integrated apparatus or an integrated computer system, wherein both the emulator and porting engine are connected to the same resource repository, allowing contexts and series which are selected to be current.

According to yet another aspect of the present invention, there is provided a computer program loadable into a memory of a computer comprising software code portions for performing, when said program is run on a computer, the steps of: retrieving attributes of a first plurality of wireless devices, each of the first plurality of wireless devices for running an application and having a screen; receiving translation information including one or more common routines available for the first plurality of wireless devices; receiving resources appropriate for the first plurality of wireless devices; receiving a first version of a source computer program; generating a first emulated device representing the first plurality of wireless devices based on the attributes; testing the first version of the source computer program on the first emulated device representing the first plurality of wireless devices, wherein a first one of the first plurality of wireless devices is of a different type than a second one of the first plurality of wireless devices.

According to yet another aspect of the present invention, there is provided a computer program loadable into a memory of a computer comprising software code portions for performing, when said program is run on a computer, the steps of: retrieving attributes of a plurality of wireless devices; receiving resources appropriate for the plurality of wireless devices; generating a plurality of emulated devices representing the plurality of wireless devices based on at least the attributes; testing a version of the source computer program on a first one of the plurality of emulated devices; testing a version of the source computer program on a second one of the plurality of emulated devices substantially simultaneously with the step of testing a version of the source computer program on a first one of the plurality of emulated devices, wherein the first one and the second one of the plurality of emulated devices receive substantially simultaneously a first input for testing, wherein the first one and the second one of the plurality of emulated devices receive substantially simultaneously a second input for testing.

According to yet another aspect of the present invention, there is provided a computer program loadable into a memory of a computer comprising software code portions for performing, when said program is run on a computer, the steps of: selecting a plurality of wireless devices by selecting device representations, each of the device representations representing a corresponding one of the plurality of wireless devices; receiving attributes of the plurality of wireless devices; receiving information from one or more libraries; receiving resources appropriate for the plurality of wireless devices; receiving a version of a source computer program; generating a plurality of executable computer programs for at least some of the plurality of wireless devices based on the selection of the plurality of wireless devices, the attributes of the plurality of wireless devices, the information from the one or more libraries, the resources, and the version of the source computer program, wherein the step of generating a plurality of executable computer programs comprises: grouping automatically the device representations into a plurality of device categories; generating automatically the plurality of executable computer programs for the plurality of device categories, wherein the number of the plurality of device categories is less than the number of the plurality of wireless devices, wherein the number of the plurality of executable computer programs is less than the number of the plurality of wireless devices, wherein the plurality of executable computer programs are for being run on the at least some of the plurality of wireless devices, wherein at least one of the plurality of executable computer programs is for being run on at least two of the plurality of wireless devices.

According to yet another aspect of the present invention, there is provided a computer program loadable into a memory of a computer comprising software code portions for generating or manipulating resources for an application for wireless devices, the software code portions for performing, when said program is run on a computer, the steps of: generating a plurality of series, each series including a set of resources, wherein resources are for an application for wireless devices; generating a plurality of contexts, each context including a plurality of series, wherein the step of generating a plurality of series comprises: generating a first series of the plurality of series, the first series including a first set of resources; wherein the step of generating a plurality of series further comprises at least one of: generating a second series of the plurality of series based on the first series of the plurality of series by automatically manipulating the first set of resources to generate a second set of resources, wherein the second series of the plurality of series includes the second set of resources, or generating a second series of the plurality of series and a third series of the plurality of series based on the first series of the plurality of series by automatically manipulating the first set of resources to generate a second set of resources and a third set of resources substantially simultaneously, wherein the second series of the plurality of series includes the second set of resources, and wherein the third series of the plurality of series includes the third set of resources, wherein the resources are to be used to generate executable computer programs for the wireless devices.

According to yet another aspect of the present invention, there is provided a computer program loadable into a memory of a computer comprising software code portions for manipulating resource images for an application for one or more wireless devices, the software code portions for performing, when said program is run on a computer, the steps of: sorting automatically resource images by size, the resource images to be used to generate one or more executable computer programs for one or more wireless devices, rearranging automatically the resource images to minimize an amount of space occupied by the resource images; reducing automatically the number of colors associated with the resource images based on an input; applying a filter on the resource images based on a threshold.

According to yet another aspect of the present invention, there is provided a computer program loadable into a memory of a computer comprising software code portions for generating executable computer programs for wireless devices, the software code portions for performing, when said program is run on a computer, the steps of: selecting a plurality of wireless devices; receiving attributes of the plurality of wireless devices; receiving translation information from one or more libraries, the translation information including at least a common routine for at least two of the plurality of wireless devices and specific routines, each specific routine for a corresponding one of the at least two of the plurality of wireless devices, the common routine for wrapping at least a difference of the at least two of the plurality of wireless devices; receiving resources appropriate for the plurality of wireless devices; generating automatically a plurality of executable computer programs for at least some of the plurality of wireless devices based on the selection of the plurality of wireless devices, the attributes of the plurality of wireless devices, the translation information, the resources, and a source computer program, wherein when the common routine is called or utilized, a first one of the plurality of executable computer programs for a first one of the at least two of the plurality of wireless devices implements a first one of the specific routines, and a second one of the plurality of executable computer programs for a second one of the at least two of the plurality of wireless devices implements a second one of the specific routines.

According to another aspect of the present invention, there is provided a computer program product comprising any of the above computer programs stored on a computer usable medium.

According to yet another aspect of the present invention, there is provided a universal emulator comprising: attributes corresponding to a first plurality of wireless devices, each of the first plurality of wireless devices for running an application; circuitry for receiving translation information including one or more common routines available for the first plurality of wireless devices, circuitry for receiving resources corresponding to the first plurality of wireless devices; circuitry for receiving a first version of a source computer program; circuitry for generating a first emulated device representing the first plurality of wireless devices based on the attributes; circuitry for testing the first version of the source computer program on the first emulated device representing the first plurality of wireless devices, wherein a first one of the first plurality of wireless devices is of a different type than a second one of the first plurality of wireless devices.

According to yet another aspect of the present invention, there is provided a concurrent emulator comprising: circuitry for receiving attributes of a plurality of wireless devices, circuitry for receiving resources appropriate for the plurality of wireless devices; circuitry for generating a plurality of emulated devices representing the plurality of wireless devices based on at least the attributes; circuitry for testing a version of the source computer program on a first one of the plurality of emulated devices; circuitry for testing a version of the source computer program on a second one of the plurality of emulated devices substantially simultaneously with the circuitry for testing a version of the source computer program on a first one of the plurality of emulated devices, wherein the first one and the second one of the plurality of emulated devices receive substantially simultaneously a first input for testing, wherein the first one and the second one of the plurality of emulated devices receive substantially simultaneously a second input for testing.

According to yet another aspect of the present invention, there is provided a build and porting apparatus comprising: circuitry for selecting a plurality of wireless devices by selecting device representations, each of the device representations representing a corresponding one of the plurality of wireless devices; circuitry for receiving attributes of the plurality of wireless devices; circuitry for receiving information from one or more libraries; circuitry for receiving resources appropriate for the plurality of wireless devices; circuitry for receiving a version of a source computer program; circuitry for generating a plurality of executable computer programs for at least some of the plurality of wireless devices based on the selection of the plurality of wireless devices, the attributes of the plurality of wireless devices, the information from the one or more libraries, the resources, and the version of the source computer program, wherein the circuitry for generating a plurality of executable computer programs comprises: circuitry for grouping automatically the device representations into a plurality of device categories; circuitry for generating automatically the plurality of executable computer programs for the plurality of device categories, wherein the number of the plurality of device categories is less than the number of the plurality of wireless devices, wherein the number of the plurality of executable computer programs is less than the number of the plurality of wireless devices, wherein the plurality of executable computer programs are for being run on the at least some of the plurality of wireless devices, and wherein at least one of the plurality of executable computer programs is for being run on at least two of the plurality of wireless devices.

According to yet another aspect of the present invention, there is provided a resource manager for controlling resources of an application for wireless devices, the resource manager comprising: circuitry for generating a plurality of series, each series including a set of resources, wherein resources are for an application for wireless devices; circuitry for generating a plurality of contexts, each context including a plurality of series, wherein the circuitry for generating a plurality of series comprises: circuitry for generating a first series of the plurality of series, the first series including a first set of resources; and wherein the circuitry for generating a plurality of series comprises at least one of: circuitry for generating a second series of the plurality of series based on the first series of the plurality of series by automatically manipulating the first set of resources to generate a second set of resources, wherein the second series of the plurality of series includes the second set of resources, or circuitry for generating a second series of the plurality of series and a third series of the plurality of series based on the first series of the plurality of series by automatically manipulating the first set of resources to generate a second set of resources and a third set of resources substantially simultaneously, wherein the second series of the plurality of series includes the second set of resources, wherein the third series of the plurality of series includes the third set of resources, and wherein the resources are to be used to generate executable computer programs for the wireless devices.

According to yet another aspect of the present invention, there is provided a resource manager for optimizing the size occupied by resource images for an application of one or more wireless devices, the resource manager comprising: circuitry for sorting automatically resource images by size, the resource images to be used to generate one or more executable computer programs for one or more wireless devices, circuitry for rearranging automatically the resource images to minimize an amount of space occupied by the resource images; circuitry for reducing automatically the number of colors associated with the resource images based on an input; circuitry for applying a filter on the resource images based on a threshold.

According to yet another aspect of the present invention, there is provided a porting apparatus for generating executable computer programs for wireless devices, the porting apparatus comprising: circuitry for selecting a plurality of wireless devices; circuitry for receiving attributes of the plurality of wireless devices; circuitry for receiving translation information from one or more libraries, the translation information including at least a common routine for at least two of the plurality of wireless devices and specific routines, each specific routine for a corresponding one of the at least two of the plurality of wireless devices, the common routine for wrapping at least a difference of the at least two of the plurality of wireless devices; circuitry for receiving resources appropriate for the plurality of wireless devices; circuitry for generating a plurality of executable computer programs for at least some of the plurality of wireless devices based on the selection of the plurality of wireless devices, the attributes of the plurality of wireless devices, the translation information, the resources, and a source computer program, wherein when the common routine is called or utilized, a first one of the plurality of executable computer programs for a first one of the at least two of the plurality of wireless devices implements a first one of the specific routines, and a second one of the plurality of executable computer programs for a second one of the at least two of the plurality of wireless devices implements a second one of the specific routines.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is a block diagram of an integrated software development and porting system in accordance with one embodiment of the present invention.

FIG. 2 is a flow diagram of an implementation of a code-formatting utility in accordance with one embodiment of the present invention.

FIG. 3 is a block diagram of a build and porting engine in accordance with one embodiment of the present invention.

FIG. 4 is a diagram illustrating how a build and porting engine sorts representations of devices into different bins in accordance with one embodiment of the present invention.

FIG. 4a is another diagram illustrating the sorting or grouping process shown in FIG. 4 in accordance with one embodiment of the present invention.

FIG. 5 is a block diagram that shows different modes of application of an operation in a resource manager across contexts and series in accordance with one embodiment of the present invention.

FIG. 6 is an example of a transformation from a first set of graphic objects to a second (or target) set of graphic objects in accordance with one embodiment of the present invention.

FIG. 7 is a block diagram of an exemplary system for developing and porting applications in accordance with one embodiment of the present invention.

FIG. 8 is an exemplary flow chart of creating an application such as a video game for wireless devices in accordance with one embodiment of the present invention.

### DETAILED DESCRIPTION OF THE INVENTION

The present invention is a novel integrated software development and porting system (ISDPS) that can speed up and assist in the entire creation of an application for wireless devices. In the following detailed description, numerous specific details are set forth to provide a full understanding of the present invention. It will be obvious, however, to one ordinarily skilled in the art that the present invention may be practiced without some of these specific details. In other instances, well-known structures and techniques have not been shown in detail so as to avoid unnecessarily obscuring the present invention.

For clarity, some of the terms are explained below:
Wireless Device: A mobile device. By way of example and not by way of limitation, wireless devices may include, for example, cellular phones, personal digital assistants (PDAs), portable game devices, and automotive devices.
Porting: A process of translating or adapting an application so that the application can run on a device.
OTA: Over-The-Air.
Device Emulator: A software program that can be used to emulate one or more behaviors of a device.
Gob: Graphic OBject.
Provisioning Server: A server solution that can receive an application and that can deliver an application to a device.
Resource: An object that is not a source code. By way of example and not by way of limitation, a resource can be a graphic, animation, music, sound effect, binary data, text, or a combination of any of these.
A series: A directory or group that contains one or more resources.
Context: A directory or group that contains one or more series.
Executable: One or more files that can be run on a device.

This invention is an integrated software development and porting system that simplifies and increases the quality and greatly speeds up the complete development cycle of applications for wireless devices. It reduces the development cost of a mobile application by a large amount and shortens the time-to-market. Porting is automatically performed inside the integrated system and it is generated from a single source code. It should be noted that a single source code may refer to a set of source code and may contain one or more files of source code. A source code may be represented in various forms (e.g., text, binary, executable). For example, a source code may be in a text form or in a non-text form such as a binary or executable form. A source computer program refers to a source code. An executable computer program refers to an executable.

The present invention simplifies the development of different builds, ensures that the application has the same behavior on different devices and reduces maintenance to its lowest level since there is only one set of source code to modify in order to make a functional change in the application. In addition to generating the different device versions (porting), it automatically generates themed and localized versions of the application if so desired. This invention helps the application developer in the creation process every step of the way to the final product. This solution has a different tool for each major activity and it helps the developer be more efficient and productive for each specific task.

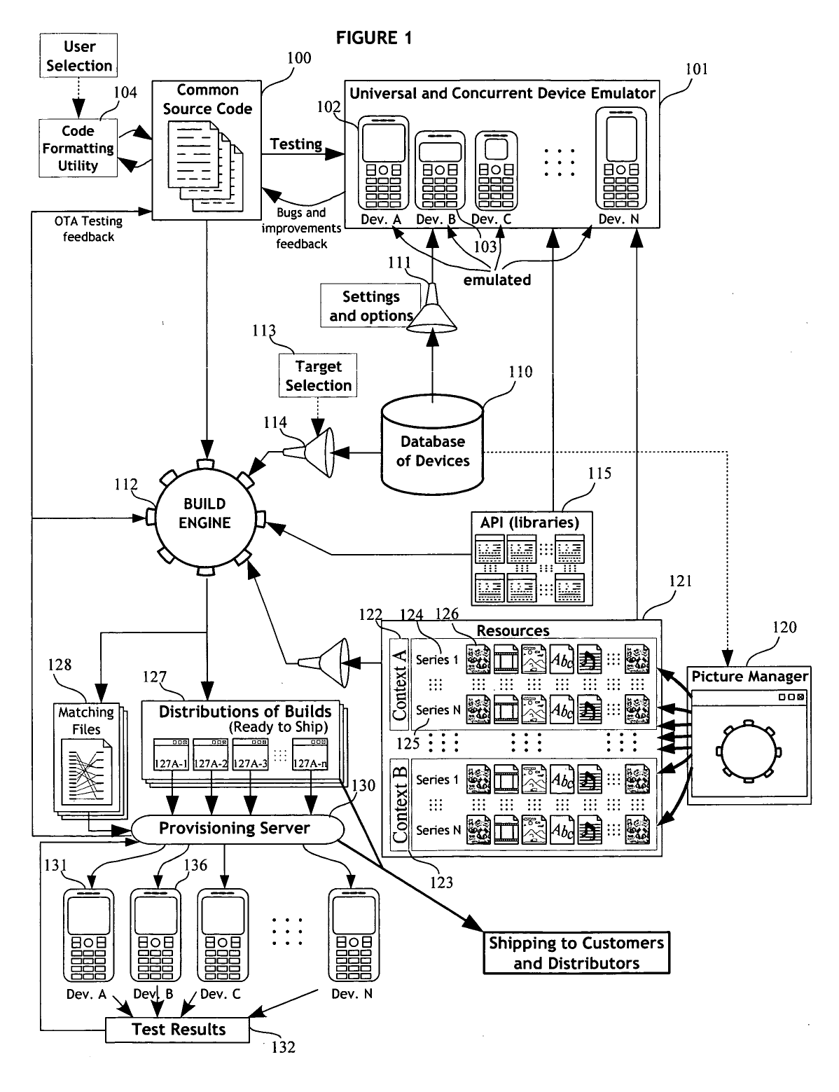

Now, referring to FIG. 1, a simplified block diagram of an integrated software development and porting system (ISDPS) is illustrated in accordance with one embodiment of the present invention. This new ISDPS environment has several integrated components that can be used separately or together to increase the efficiency in all or part of the development and porting process of an application for wireless devices. In accordance with one embodiment of the present invention and by way of example and not by way of limitation, the different integrated components may include:
a code-formatting utility 104 used to modify the code according to some preprocessor commands;
a universal and concurrent device emulator 101;
a centralized and integrated database 110 of devices;
a target selector 113 for selecting any device representations of wireless devices contained in the database 110;
a build and porting engine 112 with generic and specific libraries 115 and selected devices based on an integrated database 110 of devices;
a set of generic and specific libraries 115;
a resource manager 120 to facilitate the creation of different themes the localization and transformation of graphic, sound, text and data resources as well as the optimization of resources 121;
a provisioning server 130 used for the OTA testing of the application.

A library is any piece of code that is organized in routines callable from another piece of code or application. It may contain but is not limited to routines (or subroutines), variables and constants for instance. A generic library is a library that may be pre-installed on a device and available for use by any developer. An exemplary generic library may be a library provided by a manufacturer of wireless devices. Examples of generic libraries are MIDP implementations and the JSR API like the JSR-82 (Bluetooth).

A specific library is a library that is not available on a device by default. A specific library or libraries may include wrapper routines, specific routines, and correlation information that associate the wrapper routines with the corresponding specific routines. A wrapper routine (or subroutine) wraps a generic routine. For example, a generic routine may recognize which button is pressed on a specific device and return a code identifying the button. A wrapper routine can translate the code into a “universal” code identifying the button that is the same for all or at least some of the devices. Wrapper routines provide translations used to test “universal” emulated devices. In this example, a specific routine contains a code that is specific to a particular device rather than a “universal” code. Wrapper routines are useful, particularly, for wireless devices made by different manufacturers because a wireless device of one manufacturer will likely have some particularities that are different from those of a wireless device of another manufacturer.

This invention simplifies porting by automatically generating all the executables (or builds) for all the selected wireless devices in one simple and fast process from a single source code. The differences between the devices are automatically managed by the specific libraries of the generic and specific libraries 115 that wrap the individual particularities of the different devices under “universal” routine names of the specific library that are implemented differently in the final executables. Executables are sometimes called binaries. In J2ME, a jad and ajar file together form an executable.

Each component described above can increase the efficiency of the development or porting process, and when all these components are integrated with each other and share common features that allow them to work in tandem, the efficiency of the development and porting process may be at its optimum. This accounts for a lot of the power of the system because it simplifies many steps when the different components can communicate with each other without human intervention (usually cause of slow down and errors). Each of the components described above (e.g., a code-formatting utility, a universal and concurrent device emulator, a target selector, a build and porting engine, a resource manager, and a provisioning server) can have a graphical user interface (GUI).

In accordance with one embodiment of the present invention, by way of example and not by way of limitation, the integration happens at different levels:

First, that the tools (e.g., an emulator, a build and porting engine, a resource manager, a target selector, libraries, and a provisioning server) may be connected to the same database and share the same database of information about the wireless devices greatly simplifies the propagation of device information. The tools can receive the most current information about the devices from the database. It also simplifies the maintenance of the device information since there is only one location (i.e., one database) to update every time a new device comes to life.

Second, that the emulator 101, the build and porting engine 112 and the resource manager 120 may all be aware of the concepts of context and series and utilize the contexts and series to retrieve appropriate resources greatly simplifies the management of different versions (based on contexts) across all these tools at once instead of having to manage these versions in each one of these tools separately and having to format the resources accordingly to the usage desired by each tool.

Third, that the emulator 101 uses the specific libraries of the libraries 115 allows the emulator 101 to be universal. Indeed, this universal emulator 101, instead of having to emulate all the different quirks and specificities of each device, can now emulate generic behaviors based on implementations compatible with the libraries 115. This emulator 101 will reproduce the behaviors of actual devices (e.g., cellular phones) on a “universal” emulated device when the specific libraries of the libraries 115 are used. The specific libraries allow the emulator 101 to generate a universal emulated device and allow a source code to be tested on the universal emulated device.

Fourth, that the build and porting engine 112 uses the same specific libraries of the libraries 115 allows the single source code to call routines common to all or some of the selected devices. During the build and porting process, these common routines (or wrapper routines) are translated by the specific libraries of the libraries 115 into specific code for each device based on the specific routines and the correlation information between the wrapper routines and the specific routines. Each of the specific routines contains a routine specific to a particular device. The correlation information provides which specific routine is to be used in the build process to generate an executable for a particular device.

Fifth, that present invention incorporates certain preprocessor commands in a source code provides the following benefits: It allows the code-formatting utility 104 to comment out or uncomment parts of the source code placed between the preprocessor commands so that the emulator 101 can efficiently and easily test different portions of the source code on emulated devices. Furthermore, because the build and porting engine 112 understands the preprocessor commands, it can automatically modify a source code during a build process to generate many different versions.

Still referring to FIG. 1, the device emulator 101 is described more fully below. A device emulator is not a complete substitute for an actual device but can be close in terms of reproducing its behavior. It is useful to test prototypes of an application on a device emulator instead of having to test them on an actual device which can be time consuming because the application needs to be installed on the actual device via, for example, OTA, Bluetooth or cable.

In accordance with one embodiment of the present invention, the fact that the universal and concurrent device emulator 101 may be connected to the database 110, allows a developer to emulate any device without having to know the resolution or other data about that device. It is as simple as selecting the name of the device, and the resolution and layout of the device will be obtained from the database 110 to correctly reproduce the device in the emulator. The fact that the emulator 101 also understands the concept of context and series allows the emulation of any phone resolution as well. The emulator will know where to find the appropriate resource files by selecting the appropriate series directory given the device to emulate. If the appropriate resource files are not available, then a resource file or files that closely match the appropriate resource files may be used. In addition, the developer can easily decide which context to emulate.

In accordance with one embodiment of the present invention, the integration of the database 110 and the contexts (e.g., 122, 123) make the build and porting engine 112 powerful in that it can create many different versions (also from the different contexts) of the executables (or builds) for all the selected phones in one batch process and quickly. All of the executables for the selected wireless devices can be created quickly with a push of a button. Instead of using slow Ant tasks (which require restarting a new JVM each time), the build and porting engine program calls the compiler and post-processors directly by itself.

It should be noted that while FIG. 1 shows two contexts 122 and 123, the present invention is not limited to two contexts. The ISDPS of the present invention can create and utilize any number of contexts.

The database 110 and the generic and specific libraries 115 can be located on a local machine or on a server accessible via a local network or the internet. New versions of the tools (e.g., an emulator, a build and porting engine, a resource manager, a database, libraries, and a provisioning server) can also be copied or downloaded automatically from a repository or a local or remote server by clicking on an update button. Because the tools are modular in that each tool can be maintained separately from the other tools, the update and maintenance of each tool is easy, and a different entity can be responsible for the maintenance and update of each of the tools. As described before, when some or all of these tools are integrated, they can share the same tools. For example, an emulator and a build and porting engine can use the same source code, the same database, the same libraries, and the same repository of resources.

The database 110 contains all the device information required by the tools (e.g., the emulator, code-formatting utility, build and porting engine, resource manager and provisioning server). The database 110 may contain, but is not limited to, the following information (sometimes referred to as attributes or properties) about each device: manufacturer, model, model suffix, MIDP, CLDC, Java platform, keyboard mapping or layout of keys, release date, simultaneous keypress, number of MIDI polyphonic voices, operating system, browser support, jar size, heap size, Java virtual machine, series, screen size (sometime referred to as resolution) including screen height and width, MIDP1 height, MIDP2 height, MIDP2 full screen height, monochrome display, parent device, supported APIs (e.g., NokiaUI, JSR120, JSR135, JSR184, JSR179, JSR82, JSR75, JSR185, JSR205, VSCL, VSCL-1.0.1, VSCL-1.1.0, Sprint), bug report, connectivity (e.g., USB, 802.11, Bluetooth, network sockets, infrared, UMTS, 3G), Java image formats (e.g., bmp, .jpg, .png, .gif), Java audio formats (e.g., MIDI, AMR, MP3, WAV), Java interface connection (e.g., http, socket, UDP, serial port), camera, number of socket connections, frequency bands, and carriers.

In accordance with one embodiment of the present invention, there is only one single source code used by the emulator 101 and the build and porting engine 112. It should be noted that a single source code may refer to a set of source code and may contain one or more files of source code. The source code does not need to be manually modified by a person to perform a new emulation or create a new build during a porting process.

Once a developer selects wireless devices from, for example, a list of devices, a single source code can be used to create all of the executables (or builds) at once in one batch process automatically without time-consuming human intervention to have the application run on all the selected wireless devices. A computer may generate the executables for devices one at a time sequentially using one processor or generate the executables in parallel using multiple processors. To a human, this generation of executables will appear to take place in parallel substantially simultaneously because this generation of executables occurs automatically without human intervention once the wireless devices have been selected, and the generation occurs quickly.

A source code may make calls to routines (sometime referred to as subroutines or functions) of the specific libraries of the libraries 1115. Each of these routines (sometimes referred to as subroutines or functions) is referenced from the source code by one common name for all the devices, but during the build process, it is translated into a specific code for each wireless device utilizing the specific libraries including the wrapper routines. Wrappers provide translations for the build process.

Still referring to FIG. 1, in accordance with one embodiment of the present invention, the emulator 101 of this ISDPS is universal and concurrent. It is universal because it solves the device fragmentation issue by allowing the developer to run a single source code and emulate any wireless device that is in the database. This fragmentation issue corresponds to the management of multiple different APIs (Application Programming Interfaces) to perform the same function on different devices. By way of example and not by way of limitation, to play a sound on a Nokia cellular phone and on a Samsung cellular phone, different methods of different APIs must be used. The need to use different methods or APIs on different devices to perform the same task is called the device fragmentation issue. To solve this, the emulator includes specific libraries which hide the fragmentation by offering one unique method to perform a task instead of having to manage multiple methods of different APIs. By way of example and not by way of limitation, here are some examples of portions of specific libraries used:
jg.AudioManager class to manage/play any type of audio media.
jg.BluetoothManager class to manage/use bluetooth communications/network.
jg.GameCanvas class to manage full screen not available by default on most MIDP-1 implementation.

An example of a piece of a specific library could be a wrapper routine that wraps a generic button detection function. This generic button detection function which is available on all devices may return different button codes for the same button on different phones. For instance, if button 1 is pressed on device A and B, it may return codes 7 and 9 respectively. A specific library routine could wrap this generic function and execute a translation of the code returned to unify the response across all or at least some of the devices. For instance, the wrapper routine could return code 7 for any device when button 1 is pressed.

The emulator 101 is also concurrent because it allows the emulation and control of multiple emulated devices (e.g., 102, 103, etc.) at once. Emulated devices may have different attributes (e.g., different screen sizes, different layout of the keys, different audio capabilities). During testing, various emulated devices may be displayed on a computer screen (e.g., 102, 103, etc.) simultaneously, each emulated device emulating its corresponding actual device(s) using corresponding resources 121 (e.g., graphics, audio), corresponding attributes from the database 110 (e.g., device screen resolution, device layout), and corresponding routines from the libraries 115 (e.g., one device using a MIDP-1 implementation, another using a MIDP-2 implementation, a third device using the mobile media API (JSR-135)). The emulated devices receive each of the inputs (e.g., button presses, network data, phone events, http requests, etc.) substantially simultaneously, hence its concurrent nature.

A computer may generate emulated devices automatically—based on the selection of wireless devices and the information from the database, libraries, and resources—either sequentially or in parallel. To a human, this generation of emulated devices will appear to take place in parallel substantially simultaneously because this generation of emulated devices occurs automatically without time-consuming human intervention once the wireless devices have been selected, and the generation occurs quickly. Thus, the emulated devices can be generated in parallel substantially simultaneously.

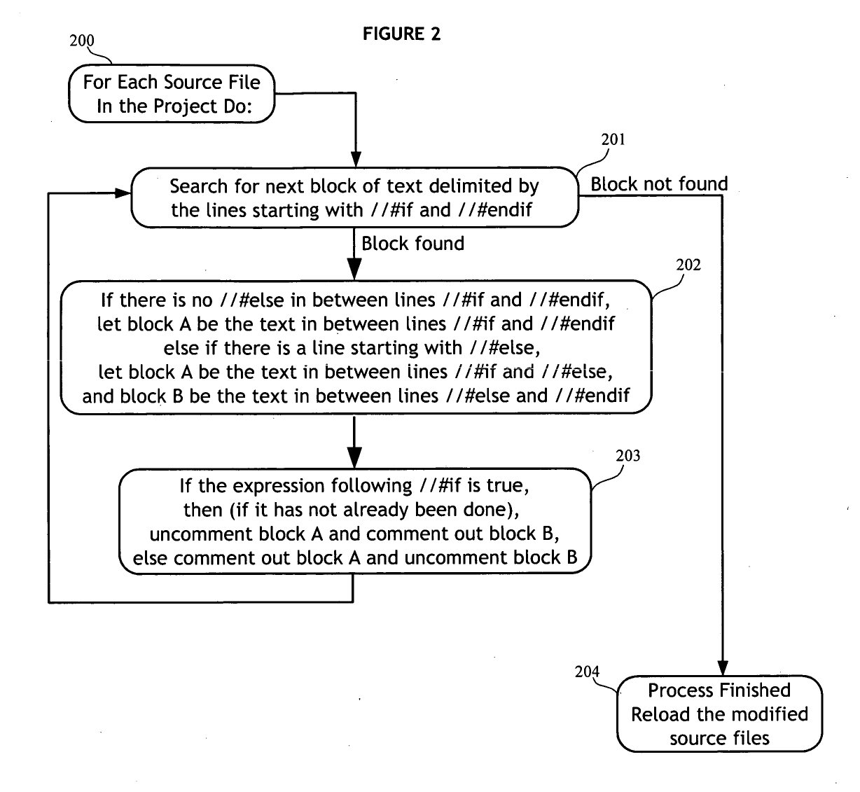

In addition, the source code can be tested on the emulated devices in parallel substantially simultaneously instead of having to sequentially rerun the emulator each time to test the source code on a different emulated device. For example, while one version of the source code is tested on an emulated device, another version of the source code can be tested on another emulated device substantially simultaneously. These different versions of the source code may be generated, for example, by activating or deactivating one or more portions of the source code, as described below with reference to FIG. 2. In another example, one version of the source code may be tested on two or more emulated devices substantially simultaneously.

This greatly speeds up the testing of the source code of the application. This allows testing the behavior of many devices using different resolutions and graphics sets all at once (or in parallel) instead of launching and testing them in a sequential order. This may also ensure that the application behaves in a similar manner on different devices.

Still referring to FIG. 1, a filter 111 may connect the integrated database 110 to the device emulator 101, may allow selecting which devices to emulate, and may feed the emulator with the necessary information or attributes regarding those devices contained in the database 110.

In accordance with one embodiment of the present invention, this emulator 101 is context and series aware. This is an important aspect of the integration of the emulator in the ISDPS environment. Being context and series aware means that when the emulator 101 is run, it knows in which context and for which series to find the resources. This enables the emulation of any version of the application by choosing the proper resources.

By way of example and not by way of limitation, the different series may contain different size graphics for the different size devices. A developer can emulate the behavior of the application on devices of different screen sizes because the emulator understands the concepts of context and series and is able to find the resources matching the device to emulate, thereby also making the emulator universal. The fact that the emulator understands the notion of context (context-awareness) allows each emulation display (e.g., 102, 103) to utilize an appropriate set of resources contained in a context corresponding to an appropriate version of the application. The fact that the emulator understands the notion of series (series-awareness) allows each emulation display (e.g., 102, 103) to utilize an appropriate series associated with, for example, the corresponding screen size and configuration of the device.

Still referring to FIG. 1, the build and porting engine 112 is described below. In accordance with one embodiment of the present invention, the build and porting engine 112 may receive the following inputs by way of example and not by way of limitation: source code 100, a selection of devices 113 and their attributes from the database 110, some specific and some generic libraries 115 and the resources 121. An output of a porting process may be multiple sets of executables (sometime referred to as builds) 127 and multiple matching files 128. An application for a device (e.g., a cellular phone) is comprised of an executable that includes one or more files to be run on the device. Each executable or build is shown as 127A-1 through 127A-n. The matching files describe how each set of the executables and each executable within a set are to be used, i.e., which set of the executables is to be used with which distributor (e.g., a wireless operator such as Cingular) and which executable of a particular set is to be used with which device. The build and porting engine 112 is also able to create zipped packages 127-128 (in which all or some of the sets of executables and matching files are zipped) that are ready to be distributed (or shipped) to customers (e.g., game publishers, distributors or wireless operators).

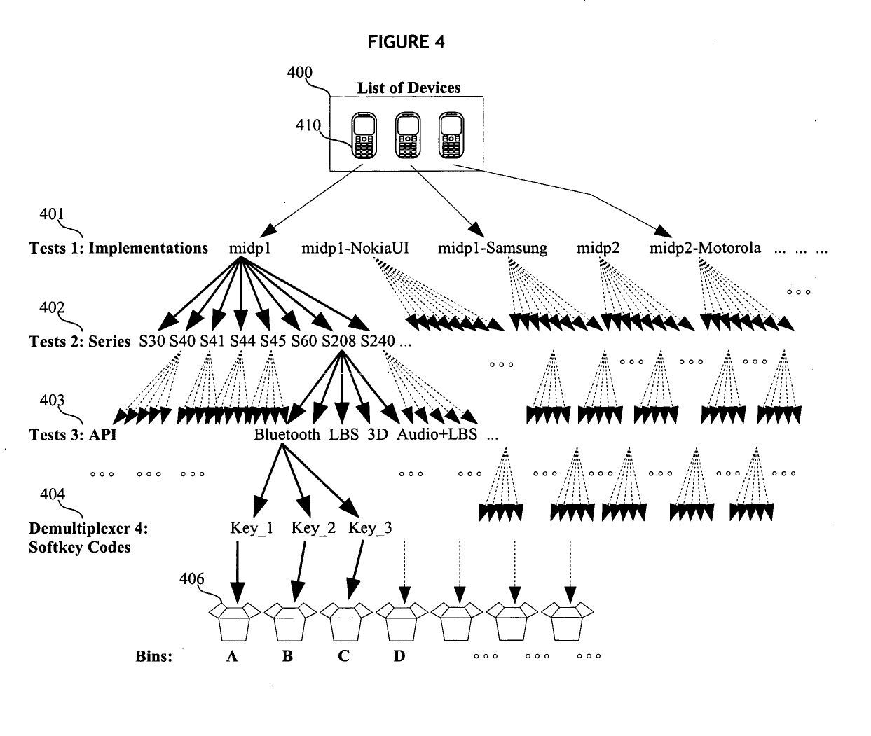

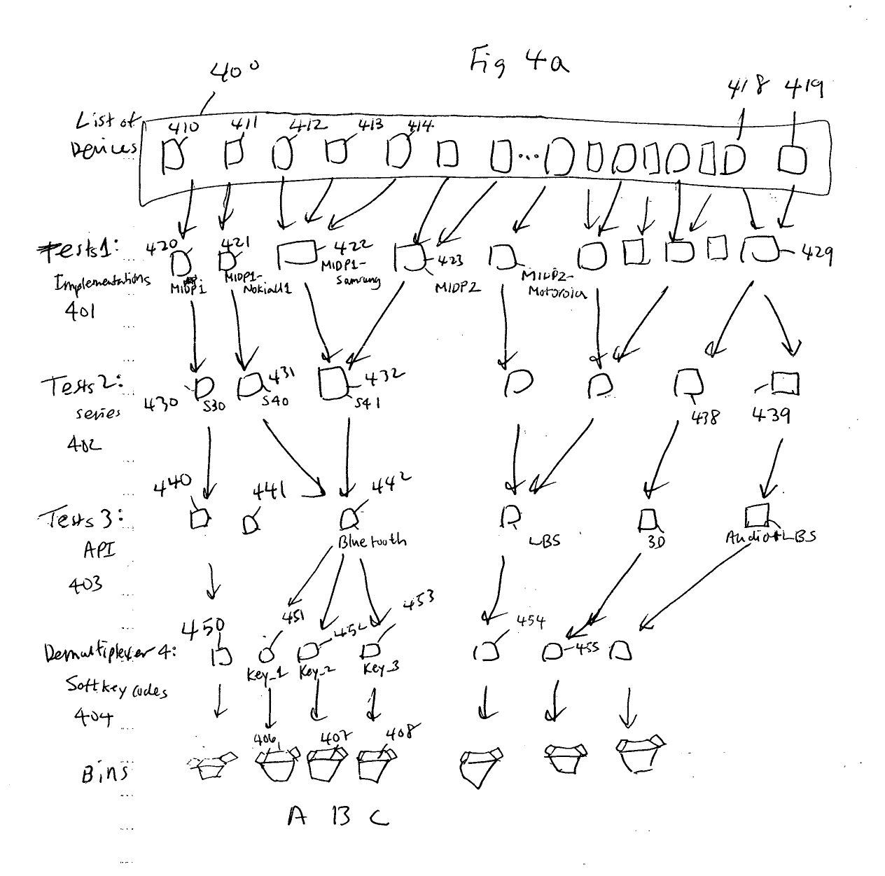

One particularity of this build and porting engine 112 is the dynamic creation of groups of devices together (see, for example, FIG. 4) based on the device selections 113 made by a developer through a filter 114, the database of devices 110, the available resources 121, and the generic and specific libraries 115.

By way of example and not by way of limitation, this automatic and intelligent process performed by the build and porting engine 112 has the following advantages over conventional build engines driven by scripts:
Scalability: if a new device is added to the database 110 and selected by a developer 113 for porting, an executable corresponding to the new device will automatically be placed in a given group of the distribution packages 127 and 128. There is no need to instruct the engine 112 what to do, like for instance updating a script file or any other configuration file.
Simplicity: the process of setting up different distribution packages 127 and 128 is as simple as selecting devices 113. All the association with the resource files 121 and generic and specific libraries 115 is done automatically by the engine 112.
Flexibility: if a library or resource changes (gets added or removed for instance), a developer does not have to modify any script or files other than modifying the affected library or resource to create the new distributions (based on the different libraries and resources); the smart engine 112 does it automatically.

In accordance with one embodiment of the present invention and by way of example and not by way of limitation, all the developer has to do to generate the distribution packages 127-128 is to select which devices to include in the distribution. This may be done via a GUI showing a list of devices that the developer can select. Then the developer clicks on a build button and the distribution packages are created automatically and quickly (for example, in less than 3 minutes for 400 devices on a Pentium 4, 3 GHz computer). The term “automatic” generally implies that an action is performed without time-consuming human intervention.

In accordance with one embodiment of the present invention, the engine 112 has the capability of creating multiple distribution packages 127-128 at once. Each distribution may contain a complete set of executables and matching files for all the devices selected by that distribution and its resources are defined in the context associated with this distribution. By way of example and not by way of limitation, adding a new distribution is as simple as clicking on the check box of that distribution to include it in the build process.

In accordance with one embodiment of the present invention, the integration of the build and porting engine 112 with the provisioning server 130 allows both of them to communicate with each other. By way of example and not by way of limitation, the build and porting engine 112 can directly and automatically upload the generated distribution packages 127-128 into a given account of the provisioning server 130 (after having entered the proper login info, once at least). The executables in the distribution packages can be tested on actual devices (e.g., 131, 136, etc.). Actual devices may have different attributes (e.g., different screen sizes, different layout of the keys). The provisioning server 130 can then feed the test results 132 back to the build and porting engine 112. The build and porting engine 112 can automatically exclude the failed devices from the device selection list, thereby making sure the distribution only targets devices for which the test results are positive.

By way of example and not by way of limitation, without having to manually log into the provisioning server 130, a developer may also download the comments of the test results, which were inputted into the provisioning server 130 by persons who tested the executables on actual devices, from within the build and porting engine 112.

In FIG. 1, in accordance with one embodiment of the present invention, the provisioning server 130 possesses a system of hierarchical accounts. The most powerful account that has all the privileges on the server is called the supervisor account. The person owning the supervisor account can create the following accounts: publisher, developer, translator, and tester, by decreasing order of hierarchy.

By way of example and not by way of limitation, the publisher account can create developer and tester accounts, and the developer account can create tester accounts. The supervisor, publishers and developers can all upload distributions of executables (sometimes referred to as products in the provisioning server) into their respective product repository. These products can only be modified or deleted by the account owner himself/herself or someone with a higher hierarchical account. Testers can only download the products belonging to the account that created them and may enter some feedback via a webpage on the result of the tests they perform.

In accordance with one embodiment of the present invention, the provisioning server 130 is compatible with the build and porting engine 112 and is integrated with the other tools in that it may be uploaded with the zipped distribution packages created by the build and porting engine 112 without any modification. The provisioning server 130 understands the syntax of the matching file inside the distribution packages. The provisioning server 130 may also be automatically uploaded (after an automatic login into a given account) with the distribution packages from the build and porting engine 112 if so desired by a developer, thereby cutting the time taken to manually log into the server and upload the distribution packages in the server. Because it understands the format, there is no manual modification of the format that is needed as it would be the case if the server was not integrated.

In accordance with one embodiment of the present invention, the provisioning server 130 has a web interface that allows a tester to type into the server the results of tests performed on actual devices after the OTA download of the executables from the provisioning server 130. OTA is a way to download an application on a wireless device by using, for example, a cellular network as the transmission medium.

The tester may also enter into the server comments pertaining to the tests. The tests are not limited to OTA provisioned tests. A tester can create test results on the web interface for various connections, including, but not limited to, a Bluetooth, data cable or infrared provisioned test. It may also enter test comments for such a test. Because the server 130 is integrated with the build and porting engine 112, a developer can retrieve the test results stored on the server 130 and read the comments from the testers to correct any problems encountered during testing. In addition, the build and porting engine may automatically exclude executables and information associated with the devices that failed a particular test if so desired for a distribution.

Still referring to FIG. 1, the resource manager 120 is described in accordance with one embodiment of the present invention. A development process starts with the creation of the source code 100 and different sets of resources 121 (e.g., graphics, animations, sounds, texts, data, etc.). The integrated resource manager software called Picture Manager 120 can optimize these resources. It can also speed up the modification and management of different versions of the resources of an application.

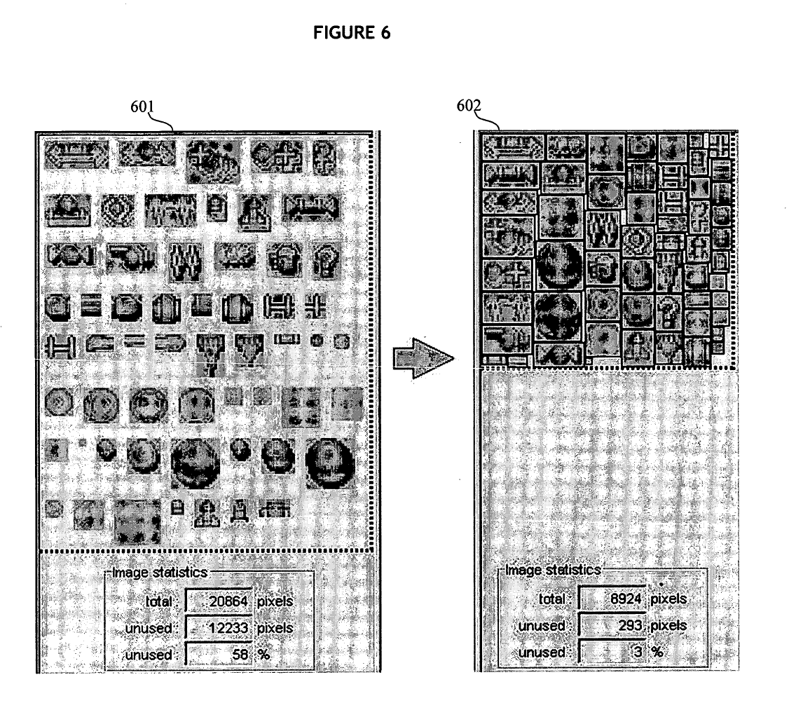

In accordance with one embodiment of the present invention and by way of example and not by way of limitation, the resource manager 120 is capable of performing the following operations on resources:
defining graphical objects (GOBS) by marking them on a bitmap of any format with an auto shrink/expand function. Gob is sometimes called sprite. It is typically a small bitmap image used in animated games. The definition of the gob is done by drawing a rectangle over the shape that defines the gob. Because it is time consuming to accurately encompass all and only those pixels that form the gob, the drawing of the rectangle is assisted by a computer if the auto-shrink and/or auto-expand functions are selected. These two functions will respectively reduce or increase the size of the rectangle to make sure it removes transparent pixels that are unused or add pixels that are part of the gob and adjacent to the drawn rectangle.
shuffling the gobs around so that they occupy the minimum amount of space possible, hence the least amount of memory when loaded in a memory of a device. A method used to arrange the gobs is explained later with reference to FIG. 6.
adding extensions and attributes to any gob or animation. Gobs and animations can have extra properties or attributes that can then be used by the application for any given purpose (e.g., the speed of a monster or the properties of a moving object). By way of example and not by way of limitation, one attribute of a gob could be a boolean variable indicating whether the gob is transparent or whether it would create a collision with other gobs. The gobs have some intrinsic attributes like their size, height and reference point (e.g., x, y coordinates).
optimizing the size of a bitmap by applying filters and reducing the number of colors. This is crucial in reducing the size of the final executables since graphics tend to use a large portion of the overall size of an application.
automatically resizing all the graphic resources from one resolution to another to adapt it to different device screens. This means converting graphics from one series to another one or more or to all the other ones automatically. The resource manager 120 is also capable of creating all the different graphics for all or some of the series from the graphics available for one series (where the name series identifies a device screen resolution).
creating, defining and playing animations composed of several animations or gobs placed in a hierarchical tree.
assigning a name for each resource object. This plain English name can then be used in the source code, thereby improving the readability of the code.
performing binary operations (e.g., not, and, or, xor) on the gob bitmaps. For instance, a gob can have a boolean “and” operation with another gob, and the resulting “anded” gob will be created from the binary and operation between the two selected gobs.
creating menu user interface via a GUI.
creating level maps based on tiles and entities that can be placed anywhere on the map. These can both have attributes that are accessible from the code.
creating the context and series directories. The resource manager 120 works with and is aware of contexts and series.
performing all or some of the operations applicable to the resources or modifications to the resources automatically in parallel on several contexts and/or series at once. This can speed up repetitive tasks. This includes performing any operation simultaneously on gobs belonging to a different series 124-125 of resources or to all or some contexts of resources. This is possible because the resource manager 120 is integrated in this ISDPS and is aware of the notion of context.
assisting in the translation of all text resources by displaying a spreadsheet where the different languages are next to each other for easier translation.

All the resource files may be grouped by contexts and then by series within a context. A context is typically a directory that contains the resources of a particular version of an application (e.g., different versions of a game). The application can have several versions with different themes for instance.

A theme is a version of an application. One application can have several themes. For instance, one version of an application can have one theme and feature an advertisement for brand A. A change in the theme creates a new version of the application, and the new version of the application can feature an advertisement for brand B. The two versions of the application would use the same source code but their respective resource files would be different. Language localization is a particular case of theming where only the language of the resource files is modified. By way of example and not by way of limitation, a developer may create a new context if he/she desires to create a different version of the application with different graphics for a certain brand advertisement or if he/she desires to create a different version of the application for a different language.

All the resources belonging to a theme will be organized in a specific context. In other words, contexts are used to group the resources belonging to a specific version of an application. Contexts are useful with respect to localizing or adapting the resources to create a different version of an application that is similar to the original one but with different graphics.

In accordance with one embodiment of the present invention, a context may be either a parent or a child. A parent context contains all the resource files necessary to the proper operation of an application. A child context contains only the resource files that are different from its parent. The child context inherits all the resource files defined in its parent except for the resource files that have been locally redefined within the child context. This concept of parent-child context greatly eases the maintenance of the resource files. All the tools in the ISDPS that use or manipulate resources (e.g., the emulator 101, the build and porting engine 112, and the resource manager 120) are aware of the notion of parent/child contexts and know that to receive all the resources from a child context, they have to obtain all the files in that context plus the files from the parent context if they are not found in the child context.

By way of example and not by way of limitation, some of the advantages of the parent/child concept for the contexts include the following: if a resource file needs to be updated, it only needs to be updated in the parent context and the update will automatically be done to all of its children if they are using the parent file, or in other words, if the children do not have a file with that same name already in their context. This method of updating only the parent files reduces the size of the overall resources by avoiding the duplication of files between parents and children.

In accordance with one embodiment of the present invention, a context may contain one or more series. Series are typically directories contained within a context. A series includes one or more resources or resource files. A series may be divided into subdirectories, each subdirectory containing one or more resources or resource files. A subdirectory may be, for instance, for a particular MIDP implementation, a trial version, or a commercial version. Resource files within a given series share the same constraints. For example, resource files within a series may be associated with one screen size or a range of screen sizes. Each series may contain the same types of resources as the other series within a context but with a different file format (e.g. jpg, png, gif) or screen size. The concept of series allows an application to work with different graphic format size. A context will contain in its root directory all the files common to the different series. The files that are series-specific will be saved in a series directory.

By way of example and not by way of limitation, a series 40 directory may be used for resources associated with a screen size of 128×128 pixels, and a series 60 directory may be used for resources associated with screen sizes in the range from 176×176 pixels to 176×208 pixels. So all the resources specific to the 176×208 pixel size screen would go into the series 60 directory whereas the resources specific to a 128×128 pixel size screen would go into the series 40 directory. Resources common to both series would go into the root directory of a given context since they would not be series-specific.

In accordance with one embodiment of the present invention, the resource manager 120 in FIG. 1 is context and series aware and allows a developer to automatically populate all series of a context with graphical resources of “master” series by applying an appropriate scaling factor to stretch the graphics to the proper size required by the series. By way of example and not by way of limitation, a developer may create all the graphics for one series (one typical screen size) and then have these graphics be automatically resized to all the other screen sizes and placed in the corresponding series directories. It can also function in a context and/or series mode where the modifications to a resource are automatically propagated to the corresponding resource of the other contexts and/or series respectively.

In FIG. 1, the database 110 can and will evolve over time to incorporate information about other wireless devices. Every time a new wireless device comes to life from a manufacturer, its information can be added to the database 110. Adding device information into the database 110 does not require any rework of the source code or any extra work to create a new distribution including executables (or builds) for the new devices because of the complete integration of the database in the suite of tools. Creating new distributions with new devices is as simple as a few clicks of a mouse button.

The integrated database 110 contains all the necessary information or attributes of the wireless devices in order to emulate, create and port the proper executables (or builds), and provision the executables to devices OTA. The database 110 is integrated because it is intimately connected to all the main components of the integrated software development and porting system, for example, from the universal and concurrent emulator 101, to the build and porting engine 112, the resource manager 120, and the provisioning server 130. The integration of the database 101 at each step of the development process allows for a consistency of information throughout the process (same data is used in different points) and also a single point of entry to update the list of devices and their characteristics. It allows for a centralization of the information in a single location. This database may also be placed on a server that is remotely accessible, thereby allowing an even greater centralization if required. The centralization of a database is useful in that it allows one entity to keep it updated and spread it to the other developers or users. This solution enables developers and users to login into a database managed by a third party.

An automatic code-formatting utility 104 is described with reference to FIG. 2. The code-formatting utility 104 allows testing of different behaviors on one or more emulated devices using a single source code. In accordance with one embodiment of the present invention, an automatic code-formatting utility 104 allows the developer to modify automatically the code depending on the value of a variable he/she sets up in a GUI used to preset the variable. This allows him/her to see and test different portions of the single source code. This utility tool is called from within any source code editor that can run Ant tasks or other executables or scripts, thereby making it quick and seamless to test different portions of the source code. The build and porting engine 112 understands the use of pre-defined preprocessor commands (starting with //#) that can perform a test on any field of the database 110 as input. This code-formatting utility 104 allows a developer to modify the code automatically according to whether an expression is true or not. This allows different portions of the source code to be tested.

Table 1 shows an example of code using a preprocessor command. By way of example and not by way of limitation, after selecting a different portion of the source code (where the MIDP_{—}1 variable is undefined), the code is automatically formatted as shown in Table 2 where the newly selected portion of the code is now uncommented whereas the same portion of the code was previously commented out and thus was not used previously.

TABLE 1

//#if MIDP==1

System.out.println(“MIDP 1 System”);

//#else
/*

System.out.println(“MIDP 2 System”);

*/
//#endif

TABLE 2

//#if MIDP==1
/*

System.out.println(“MIDP 1 System”);

*/
//#else

System.out.println(“MIDP 2 System”);

//#endif

In accordance with one embodiment of the present invention, as shown in the tables above, the code-formatting utility 104 can comment out or uncomment a block of lines that stands between two preprocessor commands.

By way of example and not by way of limitation, FIG. 2 shows a flow diagram of an implementation of a code-formatting utility 104 in accordance with one embodiment of the present invention. This utility enables different portions of the code to be tested. The build and porting engine 112 can itself modify the code, thereby selecting different portions of the source code to create different executables (or builds).

For each source code file of a project, the code-formatting utility 104 (at the emulation level) and the preprocessor (at the build level) activate or deactivate some blocks of code. The code-formatting utility 104 recognizes three statements (#if, #else, #endif) having the same meaning as the preprocessor directives of the ‘C++’ language. The difference is that the statement is prefixed “//” which corresponds to a single line of comments in Java in order to preserve the compatibility with standard Java code compilers.

Lines of code between (#if and #endif), (#if and #else) or (#else and #endif) represents a block of code that will be activated or deactivated corresponding to the boolean evaluation of the expression following the #if statement. Statements can be recursively nested without limitation.

The activation or deactivation of a block of code is made by removing or inserting the multiple line Java style comments around the block of code. The multiple line comments are defined by “/*” to open the comments and by “*/” to close the comments. The power of using Java style multiple lines of comments to activate or deactivate blocks of code is that the preprocessor can preserve the full source code compatibility with any Java syntax highlighter integrated development environment (IDE), an emulator and any Java compiler, independently of what blocks of code have been activated or deactivated.

In FIG. 2, for each source code file in a project (200), a block of text delimited by lines starting with “//#if” and ending with “//#endif” is searched (201). If no block is found, then the process is finished, and a modified source code files are reloaded (204). If, however, a block is found, and if there is no “//#else” between the lines starting with “//#if” and ending with “//#endif,” then the block found (block A) is the text between the lines starting with “//#if” and ending with “//#endif.” (202)

If, a block is found, and if there is “//#else” between the lines starting with “//#if” and ending with “//#endif,” then the first block (block A) is the text between the lines starting with “//#if” and ending with “//#else,” and the second block (block B) is the text between the lines starting with “//#else” and ending with “//#endif.” (202)

If the expression following “//#if” is true, then block A is uncommented, and block B is commented out. (203) If the expression following “//#if” is false, then block A is commented out, and block B is uncommented. (203)

This code-formatting utility 104 allows a developer to keep a single source code with multi-functionality that enables one or more blocks of code to be activated or deactivated depending on the setting of some variables, and each activated code can be tested separately. It makes the code maintenance efficient for all the different versions of the application and allows for fast selection and testing of different portions of a source code with, by way of example and not by way of limitation, a click of the mouse. The code-formatting utility 104 activates or deactivates one or more portions of a source code, or switches between different portions of a source code, based on the value of the expressions following the //#if, which are based on the value of the variables forming these expressions. In accordance with one embodiment of the present invention, a developer can choose between two presets of these variables to switch between two preset portions of a source code. These presets may be changed with a simple GUI.

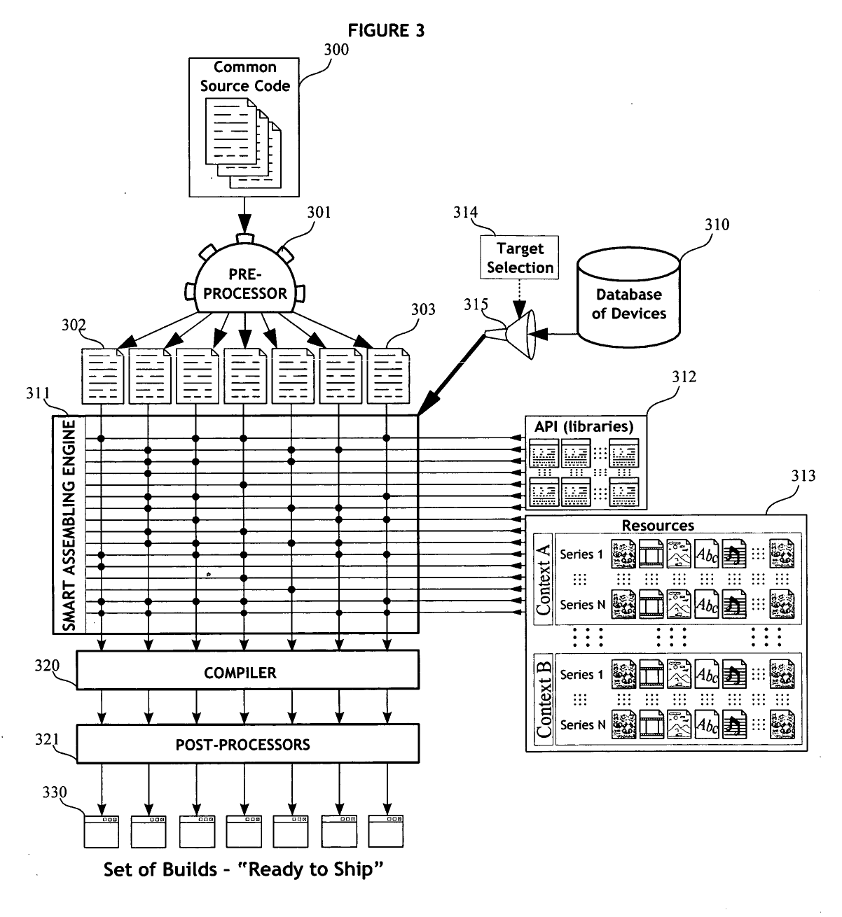

FIG. 3 shows a block diagram of the build and porting engine 112 in accordance with one embodiment of the present invention. The build and porting engine 112 may include a preprocessor 301, a smart engine 311, a compiler 320, and post-processors 321. In operation, first, the source code 300 is preprocessed by the preprocessor 301 that may generate many different versions 302-303 of the original source code. By way of example and not by way of limitation, these may be different from each other because pieces of code may have been added or subtracted accordingly to the preprocessor commands (these may be defined by a line starting with “//#”, for instance).

In accordance with one embodiment of the present invention, the smart engine 311 which is at the heart of the build and porting process receives a selection of devices 314, for instance, chosen from a list of wireless device names. The smart engine 311 then performs a sorting or grouping process described below with reference to FIGS. 4 and 4a. Based on a set of attributes residing in the database 310 and the result of the grouping of the device representations (as shown in FIGS. 4 and 4a), it then matches up and assembles the different source codes 302-303 with the generic and specific libraries 312 and the required resource files 313. This assembly engine is smart because it does not require a developer to provide information as to how to assemble the different files together. Instead, it recognizes the properties (or attributes) of the different devices, scans the generic and specific libraries 312 and the available resources 313 and then creates associations of the source code, attributes, libraries and resources. If a resource appropriate for a wireless device is not available, then the smart engine 311 uses a resource that closely matches the appropriate resource. The compiler 320 compiles the source code and the libraries. The compiled output (e.g., Java classes) is post-processed by different processors 321 to optimize the final executables. The executables 330 include resources in executable form and executables generated from the compiled source code and libraries. By way of example and not by way of limitation, in a typical Java environment, the post-processing steps may consist of an obfuscator, a shrinker and an optimizer.

The building process described with reference to FIG. 3 is automatic in that once the wireless devices are selected (and the types of tests selected as described with reference to FIG. 4 below), the executables 330 can be generated automatically without human intervention. If the executables 330 need to be modified, then instead of manually or sequentially modifying all of the executables 300, one can simply modify the source code 300, the database 310, the libraries 312, and/or the resources 313, and re-run the build and porting engine and generate the new executables automatically and quickly. This can save time because if there are, for example, one hundred executables, the present invention can eliminate making one hundred modifications to the executables by simply making a few changes to the source code 300, the database 310, the libraries 312, and/or the resources 313.

In accordance with one embodiment of the present invention, the smart engine 311 can create the smallest amount of executables 330 for a given list of chosen devices 314. Each device may typically require a different executable since they are all more or less different from each other. However, at times because a device's properties may be similar to those of another device (e.g., similar screen size, similar amount of memory, same Java virtual machine), it may be possible to run the same executable on the two different devices. Thus when the properties of one device are the same or similar to those of another device, the smart engine 311 may create one executable for both devices instead of having an executable for each device. This speeds up the building process since less executables have to be generated. It also makes distributions smaller since there are less executable files altogether in a distribution.

This paragraph explains how the build and porting engine 112 determines and creates a minimal number of executables for a given distribution. According to one embodiment of the present invention, a list of device names representing wireless devices may be displayed on a computer screen. A developer may select some of the devices by, for example, clicking a mouse on some of the representations of the devices on the list. The build and porting engine 112 sorts the selected device representations by device properties according to some user-defined criteria and groups similar device representations together into bins such that a same executable may be run on all the devices of a particular group. For each group (or bin) of device representations, only one corresponding executable is needed and generated. The number of groups is less than the number of the selected devices, and the number of executables is less than the number of selected devices. For example, if about 200 wireless devices are selected, then there may be 50 groups generated, and hence, there will be 50 executables for 500 wireless devices. This process is different from the brute force approach because it avoids the generation of one executable for each device.

The groups of device representations are dynamically formed during the sorting or grouping process and are not pre-defined. Thus the number of executables to generate is dynamically determined during the sorting or grouping process. The device representations are grouped into different bins depending on the value of some of their properties. The three main properties chosen, for instance, are the implementation, the series and the API/libraries available on the devices. In addition to these three properties, the device representations can be sorted further into bins depending on the value of some other chosen variables v1, v2, . . . , vn. By way of example and not by way of limitation, one of these variables may be a softkey ID code. The engine will not generate builds for empty bins.

FIG. 4 is a diagram illustrating how a build and porting engine sorts representations of devices into different bins in accordance with one embodiment of the present invention. It shows a list of representations of devices 400 selected by a developer. A developer may select a set of wireless devices by simply clicking on the device names from a list displayed on a screen. These device names represent the wireless devices. Each device property (or attribute) that is chosen to group the devices leads to the creation of a set of tests based on the value of the property. The build and porting engine is controlled by XML files. A GUI allows the developer to modify parts of these XML files. The XML files also have an impact on the GUI presented to the developer. A developer can, thus, select (a) certain wireless devices by simply selecting device representations representing the wireless devices and (b) types of tests or test criteria to be performed on the device representations. The types of tests or test criteria may be based on one or more of the following: attributes of the wireless devices, wireless device implementations, resources, libraries, source code, preprocessor commands, one or more demultiplexers based on the value of user-selected properties of wireless devices, and application programming interfaces.

The build and porting engine utilizes user-defined tests to automatically match device properties and form groups that share similar characteristics. Depending on the level of detail of the properties chosen to form the groups, the devices belonging to a same group will be more or less similar. For a device to belong to a group, it has to pass three sets of tests and a number of property demultiplexers. In order to pass a test, the value of the property of the device in question must match the value tested by the test. For example, if a device does not pass any of the tests of the implementation test set or of the series test set, the device is rejected from the distribution and no executable will be generated for that device. The three sets of tests are:

1. Implementation tests 401. There is a set of implementation tests that are defined by a developer in an XML file. The priority of an implementation test is defined by its placement in the XML file. A device will pass or fail an implementation test based on its implementation/coarse-grain properties such as the MIDP version, and device manufacturer name. Once a device has passed an implementation test, it is not tested against the next implementation test but instead goes to the next set of tests (e.g., series tests 402).

2. Series tests 402. The series tests relate to the size of the graphical resources. The size of the screen of a device is tested against the series size (defined in an XML file). If the series size is within the screen size of a device, then the device has passed the test for that particular series. In other words, to pass a series test, the screen size of a device has to be large enough to accommodate the graphical resources of that series. When a device has passed a series test, it is not tested against the next series test, but it will move on to the next set of tests (e.g., API/Library tests 403).

3. API/Library tests 403. The test order here is not important since a device will be tested against all the API/library tests, regardless of whether it has passed a previous API/library test or not. A device will pass a API/library test if the particular API/library is available on or for the device. Examples of APIs or libraries are JSR-135, JSR-82, JSR-120, and JSR-179. The system is easily extended to new APIs or libraries by simply adding a new test in the XML file.

After all the API/library tests have been executed, device representations may be further sorted into groups by a demuliplexer based on the value of user-selected properties of the devices. These properties are contained in the database. There can be a number of user-defined demultiplexers. A demultiplexer creates as many different groups as there are different values for the property chosen to be used in the demultiplexer. For instance, four devices that would have passed the same tests in the implementation, series and library test sets may be demultiplexed by a demultiplexer. By way of example and not by way of limitation, if the property chosen for the demultiplexer is the code of the softkeys 404 of the device keyboard, and two of the devices have the same value for that property and the other devices each has a different value, then there will be three groups of devices created with each one leading to the generation of an executable. The concept of demultiplexing can be implemented by any of the tests (e.g., tests 402, tests 403, tests 404). After this sorting process, all the groups that are not empty will have a corresponding executable created by the build and porting engine. Since this whole process is driven by XML files, the GUI is optional, but it is helpful to have an overview of the process and to configure the build. Because the sorting and grouping process discussed above is carried out by, for example, a computer, the sorting and grouping process does not involve physical sorting or grouping of the actual wireless devices, but rather sorting or grouping of device representations (e.g., device names or symbols) representing the actual wireless devices.

Table 3 shows an example of test definition pertaining to the library set of tests.

```
TABLE 3
<library id=“jsr-82” display-name=“Bluetooth” abbreviation=“BT”>
  <preprocessor>
    <variable name=“BLUETOOTH_API” value=“true”/>
  </preprocessor>
  <code-generator/>
  <resources include-dirs=“Bluetooth”/>
  <compiler references=“ref-jsr-82”/>
</library>
```

Each test may include the definition of a variable and its value (e.g., in Table 3: <variable name=“BLUETOOTH_API” value=“true”/>). Due to the integration of the tools, this variable will be understood by a code-formatting utility and an emulator if a developer decides to use it in its code. For instance, the developer could use some code specific to the devices that would pass this test by adding the piece of code shown in Table 4.

TABLE 4

```
//#if BLUETOOTH_API
  write code specific to the devices that passed the
  test called Bluetooth in the library set of tests
//#endif
```

Each test may also include the definition of a resource directory (e.g., in Table 3: <resources include-dirs=“Bluetooth”/>). This allows the tools (e.g., an emulator, a build and porting engine, and a resource manager) to use additional resources from the defined directories for the devices that passed this particular test. The directory definition defines the name of the additional directories to use to find the resource files. Thus, XML configuration files can define directories where additional resources can be used for particular executables. Each context or series directory may contain subdirectories corresponding to these defined directories to allow extra resources to be added to a particular executable.

In order to manage applications that have largely varying executable sizes, the developer may add an extra demultiplexer to the existing ones. This demultiplexer may categorize the devices according to the maximum executable size that they may use. This maximum executable size is a property of each device in the database. This allows for the creation of various directories corresponding to the different sizes of executables. By way of example and not by way of limitation, a developer may want to further split the devices into three different groups based on the maximum jar size. For instance, the maximum jar sizes could be 64 KB, 100 KB and no size limit. Table 5 shows a particular example of demultiplexer used to split the devices into three extra groups depending on the value of their maximum jar size property.

```
TABLE 5
<demultiplexer>
  <manual-split id=“jarUnkown” display-name=“Max jar unknown”
  abbreviation=““>
    <split id=“jar64” display-name=“Max jar equals to 64 KB”
    abbreviation=“J64K”>
      <condition name=“MAXJAR_64”><![CDATA[device.max_jar==
      65536]]></condition>
      <preprocessor/>
      <code-generator/>
      <resources include-dirs=“resource64kb”/>
      <compiler references=““/>
      </split>
    <split id=“jar100” display-name=“Max jar lesser or equal to 100 KB”
abbreviation=“J100K”>
      <condition name=“MAXJAR_100”>
<![CDATA[device.max_jar >
65536 && device.max_jar <= 102400]]></condition>
      <resources include-dirs=“resource 100kb”/>
      </split>
    <split id=“jarUnlimited” display-name=“Max jar
greater than 100 KB” abbreviation=“JXK”>
      <condition name=“MAXJAR_NOLIMIT”>
<![CDATA[device.max_jar >
102400]]></condition>
      <resources include-dirs=“resourceNoLimit”/>
    </split>
  </manual-split>
</demultiplexer>
```

Again, note the directory definition (starting with “<resources include-dirs”) that allow a developer to assign specific resources for the different groups of devices. Specific code based on these jar limit sizes may also be activated in the source code by the use of the following variables defined in the XML code example of Table 5: MAXJAR_{—}64, MAXJAR_{—}100, MAXJAR_NOLIMIT.

The build and porting engine is open and extensible. It is open because the sets of tests are defined in readable XML files. It is extensible because the sets of tests can easily be modified and extended by modifying the XML files. While there are four types of sorting tests shown in FIG. 4, one may employ more or less than four types of sorting tests. In FIG. 4, device representation 410 would be placed into bin A 406 if it was a MIDP 1 implementation, S208 series with a Bluetooth API and a softkey id Key_{—}1. This way, every device representation is placed into a bin and only the non-empty bins lead to the generation of the corresponding executables. The number of the non-empty bins is not pre-defined. The grouping of the device representations is done by a computer automatically, and this computer grouping process, not a developer, determines which device representation is placed into which bin.

The build and porting engine reports the following information at the end of the process:
a list of all the executables built for each distribution generated. It also shows the list of devices for which each executable is built.
which devices have been rejected from the build process because they do not belong to any group.
which devices have an executable size that is too large for the device (i.e., the jar size is larger than the maximum jar size allowed by the device).

Referring back to FIG. 3, at the end of the build process, the output is in a set of executables 330 plus a matching file that may be packed into distribution zip files ready to ship to customers. There is one distribution zip file per context that is built.

This smart engine can generate as many distribution packages as desired by a developer in one step, all at once. This quick process allows for regenerating complete distribution packages in just a few minutes (on a normal PC) instead of days or hours required by other solutions.

FIG. 4a is another representation of what is shown in FIG. 4. A shown in FIG. 4a, the sorting and grouping process described in FIG. 4 groups the device representations in a manner that the number of the final groups or device categories (shown as bins) becomes less than the number of selected device representations 400. At each test level (e.g., 401, 402, 403, and 404), device representations for devices having the same or similar attributes will be grouped together depending on the device attributes and the test criteria. For example, at tests 401, device representations 412, 413 and 414 are grouped into one group 422, and device representations 418 and 419 are grouped into another group 429. At tests 402, two groups such as 422 and 423 are grouped into one group 432. At tests 403, two groups 431 and 432 are grouped into one group 442.

It is also possible that the grouping process may generate more groups at the next level. For example, at tests 402, device representations belonging to a group 429 is demultiplexed (or multiplied) into two groups 438 and 439. At demultiplexer 404, devices representations belonging to a group 442 is demultiplexed into three groups 451, 452 and 453.

Still referring to FIG. 4a, if a device's attribute does not meet a test, then the corresponding device representation may become excluded from the grouping process, or the build and porting engine may group such a device representation into a group that closely matches the device's attribute. For example, at tests 402, if a group 430 is for a screen size of 96 pixels×64 pixels, a group 431 is for a screen size of 128 pixels×128 pixels, and a group 432 is for a screen size of 176 pixels×208 pixels, and a device has a screen size of 96 pixels×96 pixels, then the build and porting engine may place the corresponding device representation into the group 430, which closely matches the device size, rather than excluding the device representation from the grouping process.

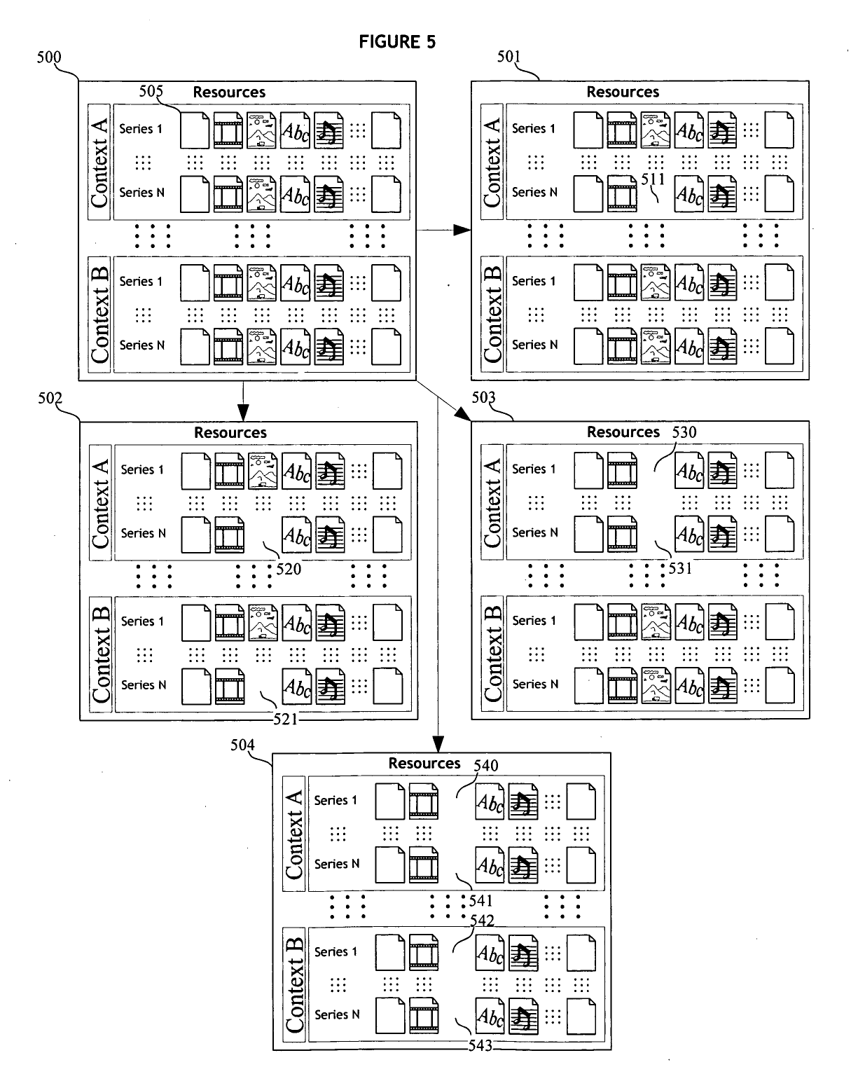

FIG. 5 is a block diagram that shows the different modes of application of an operation in the resource manager 120 across contexts and series in accordance with one embodiment of the present invention. By way of example and not by way of limitation, FIG. 5 may be interpreted as showing the application of the delete function to a gob or a file, depending on whether an object like 505 represents a gob or a resource file. Resources 500 show a complete set of resources before the application of the delete function. Resources 501 are the complete set of resources after the application of the delete function to one gob or resource file of Series N of context A in a single mode of operation. A blank space 511 represents the deleted gob or resource file. Resources 502 show the results after the operation has been applied in the parallel mode of operation on the same series of all the contexts in parallel. Blank spaces 520 and 521 represent the deleted gobs or resource files. Resources 503 show the results after the operation has been applied in the parallel mode of operation on all the series of that context. Blank spaces 530 through 531 represent the deleted gobs or resource files. Resources 504 show the results after the operation has been applied in parallel to all the series of all the contexts at once. Blank spaces 540 through 541 and blank spaces 542 through 543 represent the deleted gobs or resource files.

In accordance with one embodiment of the present invention, another valuable feature of the resource manager 120 is its ability to shrink the size of a gob bitmap by applying, for example, the following three methods:
rearranging the gobs in the bitmap so that they occupy the smallest amount of pixels.
reducing the number of colors of the palette used by the bitmap with an interactive view of the result as the number of colors is being decreased. The color selection can also be done manually by a developer by allowing the developer to select the color to be removed from a color palette presented to him/her. The process of reducing the number of colors may also be a combination of both the automatic method and the manual selection method in which case a developer can force certain colors to be used and thus prevent them from being removed from the palette.
applying a noise-reducing median filter on the bitmap with an interactive view of the result as the strength or threshold of the filter is being adjusted interactively by a developer. This median filter effectively helps in the image compression format used in general to result in a smaller file size (.png, .gif or .jpg formats, for instance). It is possible to show the actual size of the compressed graphic file in bytes for better tuning. A preview of the final result may be also shown in real-time when the parameters are modified

In accordance with one embodiment of the present invention, a method that can be used to arrange the gobs so that they occupy the smallest area possible in a bitmap is described with reference to FIG. 6. This method can shrink the size of graphics. FIG. 6 shows an example of a transformation from a first set of graphic objects to a second (or target) set of graphic objects, where the second set occupies less area than the first set. A first bitmap area 601 shows a first set of gobs, and a second bitmap area 602 shows a second (or target) set of gobs. The second set of gobs is more densely populated.

The purpose of this method is to shrink the bitmap size in terms of pixel count. In the first bitmap area 601, each gob occupies a rectangular area. Gobs can have any arbitrary size. The second bitmap area 602 is a rectangular area that has a constrained width or height but not both. Gobs can be adjacent to each other in the second bitmap area 602 but cannot overlap each other.

This method of the present invention will grow the second bitmap area 602 until all the gobs fit in it. It will do so in a vertical fashion when the width of that bitmap is fixed or in a horizontal fashion when the height is fixed. Both ways use the same method except that x/y axis and constraints are switched.

A description of a horizontal layout with a constrained height is provided below. This method includes two steps: sorting and placement. The first step is sorting the gobs by width (e.g., widest to narrowest) and then by height (e.g., tallest to shortest). The second step is placing the gobs according to their sorted order in the rectangular area in the bitmap area 602. As more gobs are added in the bitmap area 602, its overall size will grow in the unconstrained direction. The bitmap area 602 is delimited by the dotted lines. In one example, the widest gob is placed first in the top/left corner and then the second widest one just below it and so one using a serpentine pathway as illustrated below in Table 6:

TABLE 6

| | | | | | | | | |
|---|---|---|---|---|---|---|---|---|
| 0 | | 7 | --> | 8 | | 15 | --> | 16 |
| 1 | | 6 | | 9 | | 14 | | 17 |
| 2 | | 5 | | 10 | | 13 | | 18 |
| 3 | --> | 4 | | 11 | --> | 12 | | 19 . . . |

In Table 6, each number represents the corresponding sorted gob and its approximate position in the second bitmap area 602. This method places as many gobs as possible (gobs 0, 1, 2, 3 in the example of Table 6) in a first column from top to bottom. After that, the method places as many gobs as will possibly fit in a second column from bottom to top (gobs 4, 5, 6, 7 in the example of Table 6). The method repeats this process until all gobs are placed. If there is not enough room available to place a gob on the second bitmap area 602, then the bitmap area 602 grows enough to contain the gob.

Before placing a new gob, the method scans the full bitmap area 602 to see if there is an empty location large enough to accommodate that gob. Furthermore, the gobs are placed as much to the left as possible to avoid leaving empty spaces.

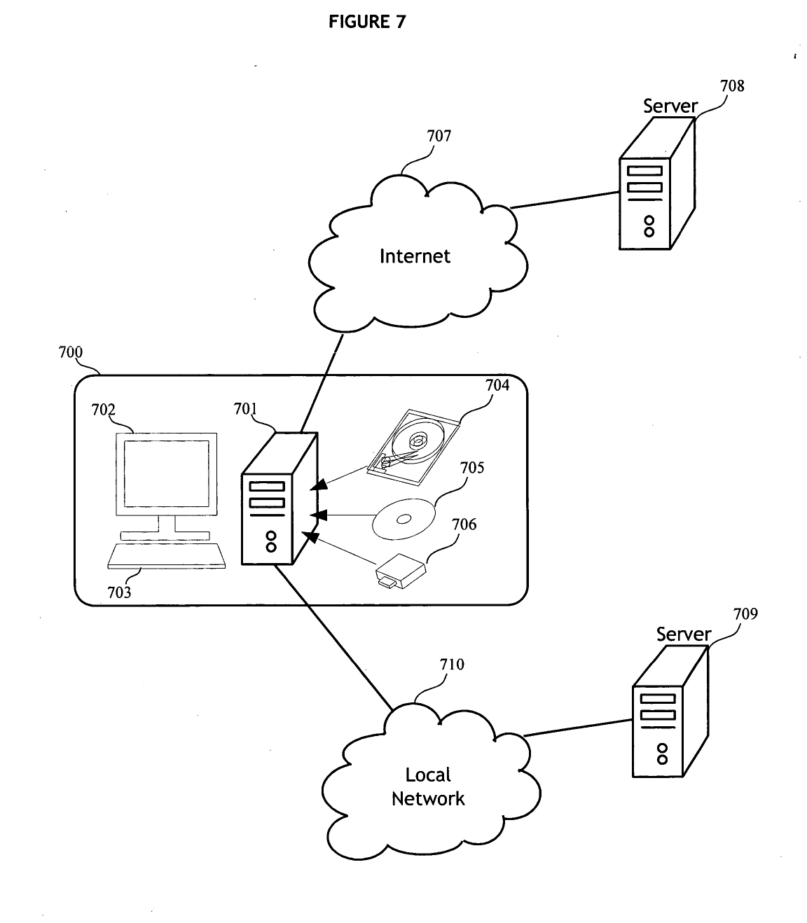

FIG. 7 is a block diagram of an exemplary system for developing and porting applications in accordance with one embodiment of the present invention. A system for developing and porting applications of the present invention may include a computer 700 with a main box 701 that contains computer hardware, a screen 702, and input devices (e.g., a keyboard 703 and a mouse (not shown)). The main box 701 may contain, for example, one or more processors and fixed and removable storage devices. Fixed storage devices may be, for example, a hard drive 704 and memories (not shown). Removal storage devices may be, for example, a CD 705, a DVD (not shown), and a flash memory 706. Other storage devices my include servers. The computer 700 may be connected to one or more servers 708 through the internet 707 or to one or more servers 709 through a local network 710 or some other types of networks.

While the work of a developer such as the source code, resources, emulator, libraries, database, resource manager, build and porting engine, and provisioning server is created, it can be processed by processors and can reside on or be transferred to at least one or more of the storage devices (e.g., hard drives, memories, CDs, DVDs, flash memories, and servers).

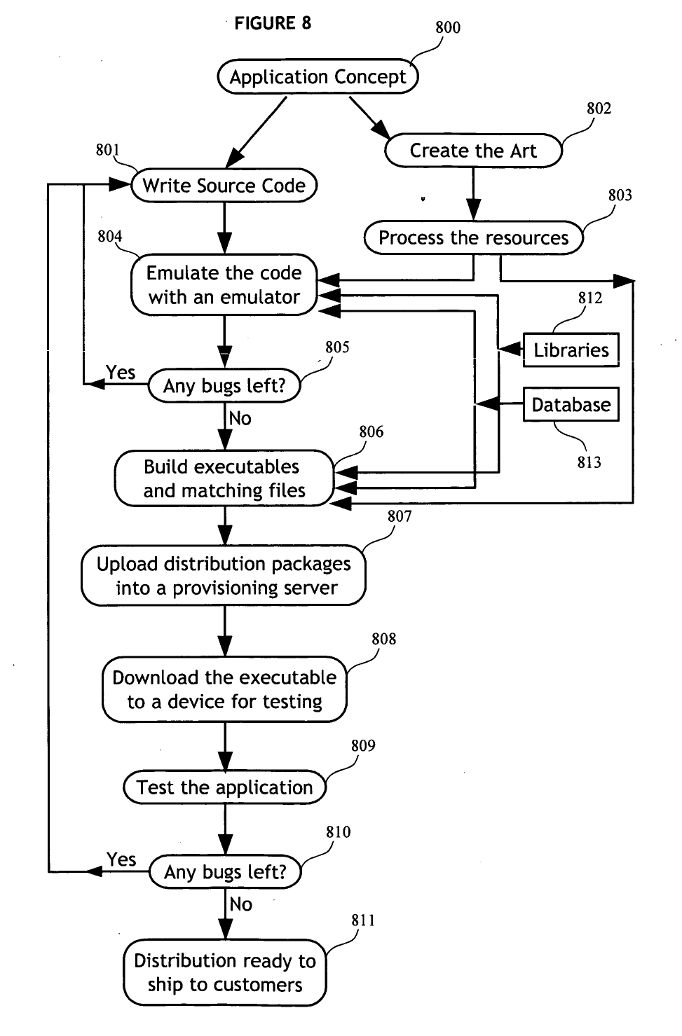

FIG. 8 is an exemplary flow chart of creating an application such as a video game for wireless devices in accordance with one embodiment of the present invention. At step 800, a game concept is created. Once the concept of the game is established, a developer typically starts programming the game by writing the source code of the game at step 801, while artists create the graphics, music, and other resources at step 802. Prior to being used by the developer, the resources are usually transformed to fit a certain format at step 803. When the source code and the resources are ready to be tested together, the developer runs an emulator at step 804 to verify that the application (including the source code, resources, libraries 812 and device information from the database 813) behaves as planned during the game concept step 800. Possible bugs and other issues are recognized at step 805. These are corrected through the iterative process (steps 801, 802, 803, 804 and 805) until the results of the emulation and testing of the application are satisfactory.

At step 806, the application is transformed into executables (or builds), and matching files are created. This process utilizes the source code, the formatted resources 803, the libraries 812 and device information from the database 813. Distribution packages (including the application in executable format and matching files) are uploaded into a provisioning server or a repository at step 807. The application is then downloaded to actual devices (e.g., cellular phones) for testing at step 808. Once installed on the actual device, the application is tested by a tester at step 809. If the tester finds bugs in the application at step 810, the bugs are fed back to the developer who can correct it by modifying the source code 801 and the resources. This process is repeated until all the issues are resolved, at which point the distribution packages including the application in executable format and matching files are ready for distribution to the operators, distributors or any other customer at step 811.

While the present invention has been particularly described with reference to the various figures and embodiments, it should be understood that these are for illustration purposes only and should not be taken as limiting the scope of the invention. There may be many other ways to implement the invention. Many changes and modifications may be made to the invention, by one having ordinary skill in the art, without departing from the spirit and scope of the invention. Thus, it is intended that the present invention covers the modifications and variations of this invention provided that they come within the scope of any claims and their equivalents. For example, even though this integrated software development and porting system has been described for J2ME, the inventions herein could be applied to BRPW, Symbian or any other development platform for wireless devices. Furthermore, while the present invention has been described for wireless devices, the invention is not limited to wireless devices and can be directed to other devices that have screens and can run applications and that can utilize one or more benefits of the present invention.

1-21. (canceled)

22. An integrated apparatus or an integrated computer system for developing a source computer program and for generating a plurality of executable computer programs to be run on a plurality of wireless devices, the integrated apparatus or the integrated computer system comprising:
a database for storing attributes of at least the plurality of wireless devices;
one or more libraries having generic data which is available for the plurality of wireless devices and specific data which is available for at least some of the plurality of wireless devices;
a resource repository for storing a plurality of resources appropriate for the plurality of wireless devices;
an emulator for emulating at least two or more of the plurality of wireless devices by generating a virtual model for each of the at least two or more of the plurality of wireless devices to be emulated, wherein each virtual model is generated based on inputs received from the database, the one or more libraries and the resource repository; and
a porting engine for receiving a version of the source computer program and for generating the plurality of executable computer programs based on the version, wherein the plurality of executable computer programs is generated based on inputs received from the database, the one or more libraries and the resource repository.

23. An integrated apparatus or an integrated computer system of claim 22, further comprising a resource manager for controlling the plurality of resources, wherein the emulator is arranged to generate a plurality of the virtual models simultaneously.

24. An integrated apparatus or an integrated computer system of claim 22, wherein the specific data in the one or more libraries is arranged to account for differences in at least some of the plurality of wireless devices in that the specific data comprises: specific routines, each of which is a computer routine specific to corresponding one or more of the at least some of the plurality of wireless devices; and at least a wrap routine arranged to wrap the differences of the specific routines into a universal routine which is a computer routine available for the at least some of the plurality of wireless devices.

25. An integrated apparatus or an integrated computer system of claim 22, wherein the porting engine is able to generate the plurality of executable computer programs from the version of the source computer program by taking into account differences of the at least some of the plurality of wireless devices using the specific data in the one or more libraries wherein wrap routines are translated by the specific data in the one or more libraries into specific routines for specific wireless devices when generating the plurality of executable computer programs.

26. An integrated apparatus or an integrated computer system of claim 22, wherein the emulator uses the specific data in the one or more libraries to account for the differences in the at least some of the plurality of wireless devices in providing a universal emulated device, which is a virtual model for at least two or more of the plurality of wireless devices.

27. An integrated apparatus or an integrated computer system of claim 22, wherein the emulator, the porting engine, the resource repository, and the one or more libraries are all connected to the same database to allow attributes associated with any of the plurality of wireless devices to be current.

28. An integrated apparatus or an integrated computer system of claim 22, further comprising a coder-formatter which is arranged to operate on a set of preprocessor commands introduced in the source computer program for identifying separate portions of the source computer program.

29. An integrated apparatus or an integrated computer system of claim 28, wherein the emulator is capable of testing the identified separate portions of the source computer program using the set of preprocessor commands and wherein the porting engine is capable of modifying the source computer program from which the plurality of executable computer programs are generated using the preprocessor commands.

30. An integrated apparatus or an integrated computer system of claim 22, further comprising:
a first user-interface enabling wireless devices to be selected from a list whereafter the executable computer programs associated with at least some of the selected wireless devices are automatically generated in parallel without human intervention; and
a second user-interface enabling wireless devices to be selected from a list whereafter virtual models associated with at least some of the selected wireless devices are automatically generated in parallel without human intervention, wherein the first and second user-interfaces are either the same or different.

31. An integrated apparatus or an integrated computer system of claim 22, wherein the plurality of resources is arranged into a set of series each comprising one or more of the resources and as a set of contexts each comprising one or more of the series, wherein sets of series and contexts define selections of user-interface themes for the plurality of wireless devices.

32. An integrated apparatus or an integrated computer system of claim 22, wherein both the emulator and porting engine are connected to the same resource repository, allowing contexts and series which are selected to be current.

33. An integrated computer system for developing a source computer program and for generating a plurality of executable computer programs to be run on a plurality of wireless devices, the integrated system comprising:
a database including attributes of at least the plurality of wireless devices;
one or more libraries;
resources;
an emulator for receiving one or more versions of the source computer program, for receiving information from the database, the one or more libraries, and the resources, for generating a first emulated device and a second emulated device based on the information, the first and second emulated devices for receiving at least one or more inputs substantially simultaneously;
a porting engine for receiving a version of the source computer program, for receiving information from the database, the one or more libraries, and the resources, and for generating a plurality of executable computer programs to be run on the plurality of wireless devices,
wherein the first emulated device represents at least a first one of the plurality of wireless devices,
wherein the second emulated device represents at least a second one of the plurality of wireless devices,
wherein the version of the source computer program is either the same as or different from the one or more versions of the source computer program.

34. An integrated computer system of claim 33, further comprising:
a resource manager for manipulating and optimizing the resources;
a code-formatter for activating or deactivating a portion of a version of the source computer program based on a preprocessor command;
a provisioning server for receiving the plurality of executable computer programs and for transmitting the plurality of executable computer programs to the plurality of wireless devices,
wherein the first emulated device represents at least the first one and a third one of the plurality of wireless devices;
wherein when a first version of the one or more versions of the source computer program is tested on the first emulated device, a second version of the one or more versions of the source computer program is tested on the second emulated device substantially simultaneously,
wherein the one or more libraries include a common routine associated with at least a first specific routine and a second specific routine,
wherein the first specific routine is for the first one of the plurality of wireless devices,
wherein the second specific routine is for the third one of the plurality of wireless devices,
wherein the common routine is for both the first one and the third one of the plurality of wireless devices,
wherein to generate the plurality of executable computer programs to be run on the plurality of wireless devices, the porting engine is capable of grouping automatically representations of the plurality of wireless devices into a plurality of device categories and generating automatically the plurality of executable computer programs for the plurality of device categories.

35. An integrated computer system of claim 34, wherein each of the following is for being updated by retrieving an update from a repository or a server: the database, the one or more libraries, the emulator, the porting engine, and the resource manager,
wherein if the plurality of executable computer programs is to be modified, the porting engine is capable of generating automatically a modified plurality of executable computer programs without manually or sequentially modifying the plurality of executable computer programs by having one or more of the following modified: one version of the source computer program, information in the database, information in the one or more libraries, and the resources,
wherein the number of the plurality of device categories is less than the number of the plurality of wireless devices,
wherein the number of the plurality of executable computer programs is less than the number of the plurality of wireless devices.

36. A computer program loadable into a memory of a computer comprising software code portions for performing the steps of:
retrieving attributes of a first plurality of wireless devices, each of the first plurality of wireless devices for running an application;
receiving translation information including one or more common routines available for the first plurality of wireless devices;
receiving resources appropriate for the first plurality of wireless devices;
receiving a first version of a source computer program;
generating a first emulated device representing the first plurality of wireless devices based on at least the attributes;
testing the first version of the source computer program on the first emulated device representing the first plurality of wireless devices,
wherein a first one of the first plurality of wireless devices is of a different type than a second one of the first plurality of wireless devices.

37. A computer program of claim 36, wherein the software code portions are for further performing the steps of:
generating a second emulated device representing one or more wireless devices;
testing a second version of the source computer program on the second emulated device, the first and second emulated devices receiving at least one or more inputs substantially simultaneously,
wherein the steps of testing the first version of the source computer program on the first emulated device and testing a second version of the source computer program on the second emulated device occur substantially simultaneously.

38. A computer program of claim 37, wherein the software code portions are for further performing the steps of:
selecting a plurality of wireless devices,
wherein the plurality of wireless devices include the first plurality of wireless devices and the one or more wireless devices,
wherein the step of generating a second emulated device is based on attributes of the one or more wireless devices,
wherein the steps of generating a first emulated device representing the first plurality of wireless devices and generating a second emulated device representing one or more wireless devices occur substantially simultaneously.

39. A computer program of claim 36, wherein at least one of the one or more common routines is for the first emulated device representing the first plurality of wireless devices,
wherein a first specific routine for the first one of the first plurality of wireless devices and a second specific routine for the second one of the first plurality of wireless devices are associated with the at least one of the one or more common routines for the first emulated device,
wherein the first specific routine and the second specific routine are different in that the first specific routine is not capable of being used for the second one of the first plurality of wireless devices,
wherein the step of testing the first version of the source computer program on the first emulated device uses the at least one of the one or more common routines,
wherein the at least one of the one or more common routines allows a single version of the source computer program to be used with the first emulated device representing the first plurality of wireless devices.

40. A computer program of claim 36, wherein the one or more common routines include at least one of: a routine to manage or play audio, a routine to manage or use a communication network, and a routine to manage full screen.

41. A computer program of claim 36, wherein the source computer program is in one of: Java or Java 2 Micro Edition,
wherein the attributes include screen resolutions of the first plurality of wireless devices.

42. A computer program of claim 36, wherein the software code portions are for further performing the steps of:
activating or deactivating a portion of a version of the source computer program based on a preprocessor command.

43. A computer program of claim 42, wherein the step of activating or deactivating is further based on a logic test,
wherein the step of activating or deactivating is performed in a single action.

44. A computer program of claim 42, wherein the step of activating or deactivating allows testing of different behaviors on the first emulated device using the single source computer program,
wherein the preprocessor command is compatible with a Java code compiler or a Java integrated development environment.

45. A computer program of claim 37, wherein the software code portions are for further performing the steps of:
generating automatically a plurality of executable computer programs for a plurality of wireless devices based on attributes of the plurality of wireless devices, elements of one or more libraries, resources appropriate for the plurality of wireless devices, and a version of the source computer program.

46. A computer program of claim 45, wherein the software code portions are for further performing the steps of:
creating a plurality of series, each series including a set of resources;
creating a plurality of contexts, each context including a plurality of series;
minimizing an amount of space occupied by a set of resources.

47. A computer program of claim 36, wherein the step of receiving resources appropriate for the first plurality of wireless devices comprises:
selecting a set of resources that closely matches the attributes of the first plurality of wireless devices.

48. A computer program of claim 45, wherein the software code portions are for further performing the steps of:
providing the plurality of executable computer programs for the plurality of wireless devices to a server;
providing the plurality of executable computer programs from the server to corresponding ones of the plurality of wireless devices,
wherein the step of retrieving attributes retrieves the attributes from a database,
wherein the step of receiving translation information receives the translation information from the one or more libraries,
wherein the step of receiving resources receives the resources from a repository of all resources, the repository including contexts,
wherein the step of generating a first emulated device representing the first plurality of wireless devices uses information from the same database,
wherein the step of testing the first version of the source computer program on the first emulated device uses information from the same one or more libraries and the same repository,
wherein the step of generating a second emulated device representing one or more wireless devices uses information from the same database,
wherein the steps of testing the first version of the source computer program on the first emulated device and testing a second version of the source computer program on the second emulated device use information from the same one or more libraries and the same repository,
wherein the step of generating automatically a plurality of executable computer programs for a plurality of wireless devices uses information from the same database, the same one or more libraries, and the same repository,
wherein attributes associated with the plurality of wireless devices are current.

49. A computer program of claim 46, wherein the step of generating a first emulated device representing the first plurality of wireless devices utilizes at least one of the plurality of series and one of the plurality of contexts;
wherein the step of generating a second emulated device representing one or more wireless devices utilizes at least one of the plurality of series and one of the plurality of contexts,
wherein the step of generating automatically a plurality of executable computer programs for a plurality of wireless devices utilizes at least one of the plurality of series and one of the plurality of contexts.

50. A computer program of claim 45, wherein each of the steps of testing the first version of the source computer program on the first emulated device, testing a second version of the source computer program on the second emulated device, and generating automatically a plurality of executable computer programs for a plurality of wireless devices utilizes a graphical user interface.

51. A computer program of claim 36, wherein the step of testing the first version of the source computer program uses at least the translation information and the resources,
wherein manufacturers of the first one of the first plurality of wireless devices and the second one of the first plurality of wireless devices are different.

52. A computer program loadable into a memory of a computer comprising software code portions for performing the steps of:
retrieving attributes of a plurality of wireless devices;
receiving resources appropriate for the plurality of wireless devices;
generating a plurality of emulated devices representing the plurality of wireless devices based on at least the attributes;
testing a version of the source computer program on a first one of the plurality of emulated devices;
testing a version of the source computer program on a second one of the plurality of emulated devices substantially simultaneously with the step of testing a version of the source computer program on a first one of the plurality of emulated devices,
wherein the first one and the second one of the plurality of emulated devices receive substantially simultaneously a first input for testing,
wherein the first one and the second one of the plurality of emulated devices receive substantially simultaneously a second input for testing.

53. A computer program of claim 52, wherein the software code portions are for further performing the steps of:
displaying the first one and second one of the plurality of emulated devices on a screen substantially simultaneously.
